(19) United States
(12) Patent Application Publication
(10) Pub. No.: US 2015/0138627 A1
(43) Pub. Date: May 21, 2015

(54) METHOD FOR PROJECTION OR BACK-PROJECTION ONTO GLASS COMPRISING A TRANSPARENT LAYERED ELEMENT HAVING DIFFUSE REFLECTION PROPERTIES

(71) Applicant: Saint-Gobain Glass France, Courbevoie (FR)

(72) Inventors: Marie-Virginie Ehrensperger, Paris (FR); Patrick Gayout, Villemomble (FR); Emmanuel Mimoun, Paris (FR); Etienne Sandre-Chardonnal, Paris (FR)

(21) Appl. No.: 14/403,358

(22) PCT Filed: May 23, 2013
(86) PCT No.: PCT/FR2013/051122

§ 371 Date: Nov. 24, 2014

(30) Foreign Application Priority Data
May 25, 2012 (FR) 1254850

(51) Int. Cl. G02F 1/29; G03B 21/62; G03B 21/60

(52) U.S. Cl. CPC G02F 1/29; G03B 21/60; G03B 21/62; G02B 1/11
USPC 359/315; 359/460; 359/443

(57) ABSTRACT

A projection or back-projection method, according to which a glazing including two main external surfaces, used as projection or back-projection screen, and a projector are available. The method includes projecting, by virtue of the projector, images viewable by spectators onto one of the sides of the glazing. The glazing includes a transparent layered element exhibiting diffuse reflection properties.

The invention relates to a projection or back-projection method in which a glazing comprising a transparent layered element having diffuse reflection properties is used as projection or back-projection screen. The invention also relates to a glazing very particularly suitable for the projection or back-projection method of the invention.

Known glazings comprise standard transparent glazings, which give rise to a specular transmission and reflection of an incident radiation on the glazing, and translucent glazings, which give rise to a diffuse transmission and reflection of an incident radiation on the glazing.

Normally, the reflection by a glazing is said to be diffuse when an incident radiation on the glazing with a given angle of incidence is reflected by the glazing in a plurality of directions. The reflection by a glazing is said to be specular when an incident radiation on the glazing with a given angle of incidence is reflected by the glazing with an angle of reflection equal to the angle of incidence. Similarly, the transmission through a glazing is said to be specular when an incident radiation on the glazing with a given angle of incidence is transmitted by the glazing with an angle of transmission equal to the angle of incidence.

Many attempts have been made to confer, on standard transparent or translucent glazings, additional properties which would allow them to be used as projection or back-projection screen.

A projection screen comprises two faces or surfaces. A main face onto which is projected the image originating from the light source positioned in the same region of space as the light source (direct projection). An opposite face on which optionally appears, by transparency, the image projected onto the main face.

Back-projection screens have available a main face and an opposite face having the same characteristics as those of the projection screens mentioned above. On the other hand, a back-projection screen differs from a projection screen in that the user and the light source are not situated in the same region of space but occur on either side of the screen. Back-projection involves necessarily positioning the projector behind the glazing and thus having available a chamber at this spot. This configuration is thus restrictive in the room which it requires for its use.

The use of transparent standard glazings as projection screen cannot be envisaged. This is because these glazings do not exhibit a diffuse reflection property; they thus do not make it possible to form images on any one of their faces and send back sharp reflections in the manner of mirrors.

The use of translucent standard glazings as projection screen also exhibits disadvantages. These translucent glazings do not make it possible to retain a clear view through the glazing.

One of the solutions proposed for improving the performance of standard translucent glazings used as projection screen consists in using glazings which can switch between a transparent state and a scattering state. These glazings are based on the use of functional film comprising active elements placed between two electrode-carrying supports. The active elements, when the film is placed under voltage, become oriented along a favored axis, which allows viewing through the functional film. Without voltage, in the absence of alignment of the active elements, the film becomes scattering and prevents viewing.

Such glazings are currently used mainly as screen for the back-projection of images in the scattering state as their properties to not allow them to be suitably used as projection screen. This is because the direct image projection onto a switchable glazing, for example a liquid-crystal glazing, is of mediocre quality due to the unsuitable optical properties of these glazings, such as the low diffuse reflection. However, in particular, the luminosity of the images projected onto these glazings generally strongly decreases when the angle of observation increases. The angle of view in projection, even in the scattering state, is greatly reduced, rendering such glazings difficult to use as projection screen.

Another solution, provided in particular in patent application EP 0 823 653, consists of a glazing combining a variable light transmission/absorption system and a variable light scattering system. This glazing can be used as back-projection or projection screen. However, it is clearly indicated that these systems are relatively satisfactory in back-projection but do not function correctly in projection. Image projection in reflection is of mediocre quality with, here again, a low luminosity and a low angle of view. Finally, image projection is only possible in the scattering state. In the transparent state, direct projection is impossible.

Screen-printed glazings, used as projection and back-projection screen, are also known. However, such glazings do not exhibit a sufficient transparency. The screen printing patterns of these glazings are always visible.

Finally, “holographic” projection glazings, onto which it is possible to project, in back-projection, images from a certain angle while maintaining the transparency of the glazing, are known. However, these glazings are limited to back-projection, making it necessary to place the projector in a very precise position. Furthermore, these products have an extremely high manufacturing cost.

The invention is thus targeted at overcoming the disadvantages of the known glazings of the prior art by providing a glazing which can be used as projection or back-projection screen, said glazing making possible in particular the direct projection of images, visible with a large angle of view, while maintaining the transparency of the glazing.

The invention also makes it possible:
to strengthen the luminosity of the image projected,
to strengthen or improve the contrast of the image projected,
to obtain an excellent angle of view, this display being produced without optical defects, that is to say with an excellent sharpness of the image displayed,
to be able to circumvent the hot spot phenomenon and to minimize the harm which can be occasioned by the formation of secondary images due to the reflection and the transmission of the projected image in the projection room.

The invention thus relates to a projection or back-projection method according to which a glazing 5 comprising two main external surfaces 10, 20, used as projection or back-projection screen, and a projector are available, said method consisting in projecting, by virtue of the projector, images viewable by spectators onto one of the sides of the glazing, characterized in that said glazing comprises a transparent layered element 1 having two smooth main external surfaces 2A, 4A, characterized in that it comprises:
two external layers 2, 4, which each form one of the two main external surfaces 2A, 4A of the layered element and which are composed of transparent materials, preferably dielectric materials, having substantially the same refractive index (n2, n4), and
a central layer 3 inserted between the external layers, this central layer 3 being formed either by a single layer which is a transparent layer, preferably a dielectric layer, with a refractive index (n3) different from that of the external layers, or a metallic layer, or by a stack of layers (3₁, 3₂, . . . , 3ₖ) which comprises at least one transparent layer, preferably a dielectric layer, with a refractive index (n3₁, n3₂, or n3ₖ) different from that of the external layers, or a metallic layer,

where each contact surface (S₀, S₁, . . . , Sₖ) between two adjacent layers of the layered element, one of which is transparent with a refractive index (n2, n4, n3, n3₁, n3₂, . . . or n3ₖ) and the other metallic or which are both transparent layers with different refractive indices, is textured and parallel to the other textured contact surfaces between two adjacent layers, one of which is transparent with a refractive index (n2, n4, n3, n3₁, n3₂, . . . or n3ₖ) and the other metallic or which are both transparent layers with different refractive indices.

In the context of the invention, a distinction is made between the metallic layers, on the one hand, for which the value of the refractive index is not important, and the transparent layers, on the other hand, preferably dielectric layers, with a predetermined refractive index, for which the difference in refractive index with respect to that of the external layers is to be taken into consideration.

According to a particularly advantageous embodiment, the glazing additionally comprises at least one antireflection coating.

According to another particularly advantageous embodiment, the glazing additionally comprises a variable light scattering system comprising a functional film capable of switching between a transparent state and a scattering state. The variable light scattering system is preferably electrically controllable. This system can comprise a functional film framed by two electrode-carrying supports, which is preferably transparent. The electrodes are directly in contact with the functional film. The electrodes preferably each comprise at least one electrically conducting layer.

The preferred embodiment of the invention combines the advantageous embodiments.

The transparent element having diffuse reflection makes it possible to obtain a glazing transparent in transmission and exhibiting a diffuse reflection. These properties contribute to a good luminosity of the projected images being obtained. This element thus makes it possible to obtain both clear viewing through the element while limiting the specular reflections of “mirror” type. The central layer promotes the diffuse reflection, thus making possible the direct projection of an image onto any one of the sides of the glazing incorporating the transparent layered element, the image being formed in the central layer.

The addition of an antireflection coating makes it possible to reduce the multiple reflections inside the layered element and thus to improve the quality of the images projected.

The combination with a variable light scattering system, when this system is in its transparent state, does not modify the properties of the glazing. On the other hand, when the system is in its scattering state, the quality of the images obtained in direct projection is improved as the diffuse reflection of the layered element is added to the diffuse reflection of the variable light scattering system. This synergistic interaction makes it possible to obtain a better luminosity and a better contrast of the projected image. The presence of a variable light scattering system, preferably electrically controllable, thus makes it possible to obtain a glazing which can switch between a transparent state and a scattering state but on which direct projection is possible with a good angle of view both in the transparent state and in the scattering state.

The glazing according to the invention thus makes it possible to produce the direct projection of images. The projected images are available with an excellent angle of view which can range up to 180°. This is because an observer located at an angle of approximately −90° or +90° is capable of distinctly seeing a projected image or of reading a projected text on the glazing of the invention.

The properties of the glazing, in particular the very large angle of view, make it possible not to impose a particular constraint on the position of the projector. For example, the projector can be placed so that the specular reflection and/or the non-diffuse transmission of the lamp of the projector is/are not visible to the observers, without detrimentally affecting the quality of the projection. The hot spot phenomenon is thus avoided.

This same property makes it possible to minimize the harm which may be occasioned by the formation of secondary images. The secondary images are due to:
the specular reflection of the light projected onto the glazing, it being possible for an image then to be formed on another surface of the projection room,
the non-diffuse transmission of the light projected through the glazing, it being possible for an image then to be formed on another surface of the projection room,

This nuisance being able to be minimized by positioning the projector so that these secondary images are formed at a spot not troublesome to the observer, for example on the ground.

The solution of the invention constitutes an improvement to the existing glazings for use as projection screen from a technical viewpoint but also from an economic viewpoint due to the low additional cost generated by the presence of the transparent layered element having diffuse reflection properties.

Throughout the description, the glazing according to the invention is regarded as positioned horizontally, with its first face, directed downward, defining a lower main external surface 10 and its second face, opposite the first face, directed upward, defining an upper main external surface 20; the meanings of the expressions “above” and “below” are thus to be considered with respect to this orientation. Unless specifically stipulated, the expressions “above” and “below” do not necessarily mean that two elements, layers, coatings and/or systems are positioned in contact with one another. The terms “lower” and “upper” are used here with reference to this positioning.

The glazing can furthermore comprise at least one additional layer positioned above or below the layered element and/or optionally the variable light scattering system. Said additional layer or layers of the glazing can consist of transparent materials, preferably dielectric materials, having very substantially the same refractive index or having different refractive indices which the transparent materials, preferably dielectric materials, of the external layers of the layered element. These additional layers are preferably chosen from:
transparent substrates chosen from polymers, glasses or ceramics comprising two smooth main surfaces,
curable materials initially in a liquid or pasty viscous state suitable for shaping operations,
inserts made of thermoformable or pressure-sensitive plastic.

The glazing comprises two main upper and lower external surfaces 10, 20. The main external surfaces of the glazing can be coincident with the main external surfaces of the layered element, for example if the glazing does not comprise an additional layer. On the other hand, if the glazing comprises:
at least one additional upper layer, the upper main external surface of the glazing will be coincident with the upper main external surface of the additional upper layer,
at least one additional lower layer, the lower main external surface of the glazing will be coincident with the lower main external surface of the additional lower layer.

Within the meaning of the invention, the term “index” refers to the optical refractive index, measured at the wavelength of 550 nm.

According to the invention, a thin layer is a layer with a thickness of less than 1 μm.

Two transparent materials or transparent layers, preferably dielectric materials or layers, have substantially the same refractive index or have their refractive indices substantially equal when the two transparent materials, preferably dielectric materials, have refractive indices for which the absolute value of the difference between their refractive indices at 550 nm is less than or equal to 0.15. According to the invention, the absolute value of the difference in refractive index at 550 nm between the constituent transparent materials, preferably dielectric materials, of the two external layers of the layered element is, by preferably increasing order: less than or equal to 0.05, less than or equal to 0.02, less than or equal to 0.018, less than or equal to 0.015, less than or equal to 0.01, less than or equal to 0.005.

Two transparent materials or transparent layers, preferably dielectric materials or layers, have different refractive indices when the absolute value of the difference between their refractive indices at 550 nm is strictly greater than 0.15. According to an advantageous characteristic, the absolute value of the difference in refractive index at 550 nm between, on the one hand, the external layers and, on the other hand, at least one transparent layer with a refractive index (n3, n3₁, n3₂, . . . n3ₖ) of the central layer is greater than or equal to 0.3, preferably greater than or equal to 0.5, more preferably greater than or equal to 0.8.

This relatively great difference in refractive index occurs at at least one textured contact surface internal to the layered element. This makes it possible to promote the reflection of radiation on this textured contact surface, that is to say a diffuse reflection of the radiation by the layered element.

The contact surface between two adjacent layers is the interface between the two adjacent layers.

A transparent element is an element through which there is transmission of radiation, at least in the wavelength ranges of use for the targeted application of the element. Preferably, the element is transparent at least in the visible wavelength range.

According to the invention, the transparent materials or the transparent layers refer in particular:
to the external layers 2, 4 consisting of transparent materials with the refractive index (n2, n4),
to the central layer 3 formed by a transparent layer with the refractive index (n3),
to the stack of layers (3₁, 3₂, . . . , 3ₖ) which comprises at least one transparent layer with a refractive index (n3₁, n3₂, or n3ₖ) different from that of the external layers.

Preferably, the transparent materials or transparent layers are of organic or inorganic nature. Preferably, the transparent materials or transparent layers are not metallic. The inorganic transparent materials or transparent layers can be chosen from oxides, nitrides or halides of one or more transition metals, nonmetals or alkaline earth metals. The transition metals, nonmetals or alkaline earth metals are preferably chosen from silicon, titanium, tin, zinc, indium, aluminum, molybdenum, niobium, zirconium or magnesium. The organic dielectric materials or layers are chosen from polymers.

These transparent materials or transparent layers are preferably dielectric. A dielectric material or layer is a nonmetallic material or layer. It is considered that a dielectric material or layer is a material or a layer of low electrical conductivity, preferably of less than 10⁴ S/m and optionally of less than 100 S/m. It can also be considered that a dielectric material or layer is a material or a layer exhibiting a higher resistivity than that of the metals. The dielectric materials or layers of the invention exhibit a resistivity of greater than 1 ohm·centimeter (Ω·cm), preferably of greater than
Ω·cm and optionally of greater than 10⁴ Ω·cm.

According to a specific embodiment of the invention, the transparent layered element is used as electrode-carrying support. For example, the transparent layered element can constitute one of the electrode-carrying supports of the variable light scattering system. The lower external layer then performs the role of support and the assembly composed of the central layer and of the upper external layer performs the role of electrode.

According to this embodiment, the central layer preferably comprises at least one metallic layer. When the layers located above this layer are transparent layers with a refractive index n4, n3₁, n3₂, n3ₖ, these layers have to be conducting to a certain extent. The transparent materials or transparent layers can thus be electrically conducting layers. This is because these transparent materials or transparent layers have to exhibit a resistivity which is sufficiently “low” not to render insulating the electrode composed of this layer or these layers and of the central layer of the layered element. These layers or materials preferably have a resistivity of less than 1 ohm·cm, preferably of less than 10⁻² ohm·cm.

A textured or rough surface is a surface for which the surface properties vary at a greater scale than the wavelength of the incident radiation on the surface. The incident radiation is then transmitted and reflected in diffuse fashion by the surface. Preferably, a textured or rough surface according to the invention exhibits a roughness parameter corresponding to the arithmetic mean deviation Ra of at least 0.5 μm, in particular between 1 and 5 μm (corresponding to the arithmetic mean of all the absolute distances of the roughness profile R measured from a median line of the profile along an evaluation length).

A smooth surface is a surface for which the surface irregularities are such that the radiation is not deflected by these surface irregularities. The incident radiation is then transmitted and reflected in specular fashion by the surface. Preferably, a smooth surface is a surface for which the surface irregularities have dimensions which are smaller than the wavelength of the incident radiation on the surface or which are much greater (large-scale undulations).

However, the external layers or the additional layers can exhibit some surface irregularities provided that these layers are in contact with one or more additional layers which are composed of dielectric materials having substantially the same refractive index and which exhibit, on their face opposite that in contact with said layer exhibiting some irregularities, a smooth surface as defined above.

Preferably, a smooth surface is a surface exhibiting either a roughness parameter corresponding to the arithmetic mean deviation Ra of less than 0.1 μm, preferably of less than 0.01 μm, or slopes of less than 10°.

A glazing comprises at least one transparent organic or inorganic substrate.

The layered element can be rigid or flexible. It can in particular be a glazing composed for example based on glass or polymer. It can also be a flexible polymer-based film capable in particular of being added to a surface in order to confer diffuse reflection properties thereon while retaining its transmission properties.

The applicant has discovered that the particularly advantageous properties of the layered element of the invention are due to the agreement in index between the external layers, that is to say to the fact that these two layers have substantially the same refractive index. According to the invention, the agreement in index or difference in index corresponds to the absolute value of the difference in refractive index at 550 nm between the constituent transparent materials, preferably dielectric materials, of the two external layers of the layered element. The smaller the difference in index, the sharper the viewing through the glazing. The extreme sharpness of the viewing through the layered element is due to the most tailored agreement in index possible.

By virtue of the invention, a specular transmission and a diffuse reflection of an incident radiation on the layered element is obtained. The specular transmission guarantees a sharp view through the layered element. The diffuse reflection makes it possible to prevent sharp reflections on the layered element and the risks of dazzling.

The diffuse reflection on the layered element originates from that each contact surface between two adjacent layers, one of which is transparent and the other metallic or which are two transparent layers with different refractive indices, is textured. Thus, when an incident radiation on the layered element reaches such a contact surface, it is reflected by the metallic layer or as a result of the difference in refractive index between the two transparent layers and, as the contact surface is textured, the reflection is diffuse.

The specular transmission originates from that the two external layers of the layered element have smooth main external surfaces and are composed of materials having substantially the same refractive index and from that each textured contact surface between two adjacent layers of the layered element, one of which is transparent with a refractive index (n2, n4, n3, n3₁, n3₂, . . . or n3ₖ) and the other metallic or which are two transparent layers with different refractive indices, is parallel to the other textured contact surfaces between two adjacent layers, one of which is transparent with a refractive index (n2, n4, n3, n3₁, n3₂, or n3ₖ) and the other metallic or which are two transparent layers with different refractive indices.

The smooth external surfaces of the layered element make possible a specular transmission of radiation at each air/external layer interface, that is to say make possible the entry of a radiation from the air into an external layer or the departure of a radiation from an external layer into the air, without modifying the direction of the radiation.

The parallelism of the textured contact surfaces implies that the constituent or each constituent layer of the central layer which is transparent with a different refractive index from that of the external layers or which is metallic exhibits a uniform thickness perpendicular to the contact surfaces of the central layer with the external layers.

This uniformity in the thickness can be universal over the entire extent of the texture or local to sections of the texture. In particular, when the texture exhibits variations in slope, the thickness between two consecutive textured contact surfaces can change, per section, as a function of the slope of the texture, the textured contact surfaces remaining, however, always parallel to one another. This case exists in particular for a layer deposited by cathode sputtering, where the thickness of the layer decreases as the slope of the texture increases. Thus, locally, on each texture section having a given slope, the thickness of the layer remains constant but the thickness of the layer is different between a first texture section having a first slope and a second texture section having a second slope different from the first slope.

Advantageously, in order to obtain the parallelism of the textured contact surfaces inside the layered element, the constituent layer or each constituent layer of the central layer is a layer deposited by cathode sputtering. This is because cathode sputtering, in particular magnetic-field assisted cathode sputtering, guarantees that the surfaces delimiting the layer are parallel to one another, which is not the case with other deposition techniques, such as evaporation or chemical vapor deposition (CVD), or also the sol-gel process. In point of fact, the parallelism of the textured contact surfaces inside the layered element is essential in order to obtain a specular transmission through the element.

An incident radiation on a first external layer of the layered element crosses this first external layer without modifying its direction. As a result of the difference in nature, transparent with a refractive index (n2, n4, n3, n3₁, n3₂, . . . or n3ₖ) or metallic, or of the difference in refractive index between the first external layer and at least one layer of the central layer, the radiation is subsequently refracted in the central layer. As, on the one hand, the textured contact surfaces between two adjacent layers of the layered element, one of which is transparent and the other metallic or which are two transparent layers with different refractive indices, are all parallel to one another and, on the other hand, the second external layer has substantially the same refractive index as the first external layer, the angle of refraction of the radiation in the second external layer starting from the central layer is equal to the angle of incidence of the radiation on the central layer starting from the first external layer, in accordance with the Snell-Descartes law for the refraction.

The radiation thus emerges from the second external layer of the layered element along a direction which is the same as its direction of incidence on the first external layer of the element. The transmission of the radiation by the layered element is thus specular. A clear view through the layered element, that is to say without the layered element being translucent, is thus obtained, by virtue of the specular transmission properties of the layered element.

According to one aspect of the invention, advantage is taken of the diffuse reflection properties of the layered element to reflect a large portion of the radiation, in a plurality of directions, on the side of incidence of the radiation. This strong diffuse reflection is obtained while having a clear view through the layered element, that is to say without the layered element being translucent, by virtue of the specular transmission properties of the layered element. Such a transparent layered element having strong diffuse reflection exhibits a degree of interest for applications such as display or projection screens.

According to one aspect of the invention, at least one of the two external layers of the layered element is composed of dielectric materials and is chosen from:
transparent substrates, one of the main surfaces of which is textured and the other main surface of which is smooth, preferably chosen from polymers, glasses or ceramics,
a layer of transparent material, preferably dielectric material, chosen from oxides, nitrides or halides of one or more transition metals, nonmetals or alkaline earth metals,
a layer based on curable materials initially in a liquid or pasty viscous state suitable for shaping operations comprising:
   photocrosslinkable and/or photopolymerizable materials,
   layers deposited by a sol-gel process,
   enamel layers,
inserts or interleaves of thermoformable or pressure-sensitive plastic which can preferably be based on polymers chosen from polyvinyl butyrals (PVB), polyvinyl chlorides (PVC), polyurethanes (PU), polyethylene terephthalates or ethylene/vinyl acetates (EVA).

The texturing of one of the main surfaces of the transparent substrates can be obtained by any known texturing process, for example by embossing the surface of the substrate, heated beforehand to a temperature at which it is possible to deform it, in particular by rolling by means of a roller having, at its surface, a texturing complementary to the texturing to be formed on the substrate; by abrasion by means of abrasive particles or surfaces, in particular by sandblasting; by chemical treatment, in particular treatment with acid in the case of a glass substrate; by molding, in particular injection molding, in the case of a substrate made of thermoplastic polymer; or by engraving.

When the transparent substrate is made of polymer, it can be rigid or flexible. Examples of polymers suitable according to the invention comprise in particular:
polyesters, such as polyethylene terephthalate (PET), polybutylene terephthalate (PBT) or polyethylene naphthalate (PEN);
polyacrylates, such as polymethyl methacrylate (PMMA);
polycarbonates;
polyurethanes;
polyamides;
polyimides;
fluoropolymers, such as fluoroesters, for example ethylene-tetrafluoroethylene (ETFE), polyvinylidene fluoride (PVDF), polychlorotrifluoroethylene (PCTFE), ethylene-chlorotrifluoroethylene (ECTFE) or fluorinated ethylene-propylene copolymers (FEP);
photocrosslinkable and/or photopolymerizable resins, such as thiolene, polyurethane, urethane-acrylate or polyester-acrylate resins, and
polythiourethanes.

These polymers generally exhibit a refractive index range varying from 1.3 to 1.7.

Examples of pretextured glass substrates which can be used directly as external layer of the layered element comprise:
glass substrates sold by Saint-Gobain Glass in the Satinovo® range, which are pretextured and exhibit, on one of their main surfaces, a texture obtained by sandblasting or acid attack;
glass substrates sold by Saint-Gobain Glass in the Albarino® S, P or G range or in the Masterglass® range, which exhibit, on one of their main surfaces, a texture obtained by rolling;
high-index glass substrates which are textured by sandblasting, such as flint glass, for example sold by Schott under the references SF6 (n=1.81), 7SF57 (n=1.85), N-SF66 (n=1.92) and P-SF68 (n=2.00).

When each of the two external layers of the layered element is formed by a transparent substrate, the two transparent substrates have textures which complement one another.

The textured external layer of the layered element can be composed simply of a layer of transparent material, preferably dielectric material, chosen from oxides, nitrides or halides of one or more transition metals, nonmetals or alkaline earth metals. The transition metals, nonmetals or alkaline earth metals are preferably chosen from silicon, titanium, tin, zinc, aluminum, molybdenum, niobium, zirconium or magnesium. This thin layer of dielectric material can be composed of materials chosen from materials having a high refractive index, such as Si₃N₄, AlN, NbN, SnO₂, ZnO, SnZnO, Al₂O₃, MoO₃, NbO, TiO₂ or ZrO₂, and materials having low refractive indices, such as SiO₂, MgF₂ or AlF₃. This layer is preferably used as upper external layer of the layered element and can be deposited by a cathode sputtering deposition technique, in particular a magnetic-field assisted cathode sputtering deposition technique, by evaporation, by chemical vapor deposition (CVD), on a glazing already comprising a lower external layer and a central layer. On the other hand, the depositions produced by cathode sputtering conform to the surface. The layer thus deposited thus subsequently has to be polished, so as to obtain a flat main external surface. These dielectric layers thus comprise a textured surface matching the surface roughness of the central layer and a main external surface opposite this surface which is flat.

The external layers of the layered element can also be based on curable materials initially in a liquid or pasty viscous state suitable for shaping operations. Preferably, these layers are used as upper external layers of the layered element.

The layer initially deposited in a liquid or pasty viscous state can be a layer of photocrosslinkable and/or photopolymerizable material. Preferably, this photocrosslinkable and/or photopolymerizable material is provided in the liquid form at ambient temperature and gives, when it has been irradiated and photocrosslinked and/or photopolymerized, a transparent solid devoid of bubbles or any other irregularity. It can in particular be a resin, such as those normally used as adhesives or surface coatings. These resins are generally based on monomers/comonomers/prepolymers of epoxy, epoxysilane, acrylate, methacrylate, acrylic acid or methacrylic acid type. Mention may be made, for example, of thiolene, polyurethane, urethane-acrylate or polyester-acrylate resins. Instead of a resin, it can be a photocrosslinkable aqueous gel, such as a polyacrylamide gel. Examples of photocrosslinkable and/or photopolymerizable resins which can be used in the present invention comprise the products sold by Norland Optics under the NOA® Norland Optical Adhesives brand, such as, for example, the NOA®65 and NOA®75 products.

In an alternative form, the external layer initially deposited in a liquid or pasty viscous state can be a sol-gel layer deposited by a sol-gel process comprising a silica-based matrix obtained according to a sol-gel process.

The sol-gel process consists, in a first step, in preparing a solution referred to as “sol-gel solution” comprising precursors which give rise, in the presence of water, to polymerization reactions. When this sol-gel solution is deposited on a surface, due to the presence of water in the sol-gel solution or on contact with ambient moisture, the precursors hydrolyze and condense to form a network in which the solvent is trapped. These polymerization reactions result in the formation of increasingly condensed entities, which lead to colloidal particles forming sols and then gels. The drying and the densification of these gels, at a temperature of the order of a few hundred degrees, results, in the presence of silica-based precursor, in a sol-gel layer corresponding to a glass, the characteristics of which are similar to those of a conventional glass.

Preferably, the sol-gel layers are used as upper external layer of the layered element. As a result of their viscosity, the sol-gel solutions, in the form of a colloidal solution or of a gel, can be easily deposited on the textured main surface of the central layer opposite the first external layer, conforming to the texture of this surface. The sol-gel layer will “fill in” the roughness of the central layer. This is because this layer comprises a surface matching the surface roughness of the central layer, which is thus textured, and a main external surface opposite this surface which is flat. The layers deposited by a sol-gel process thus provide a planarization of the surface of the layered element.

The sol-gel layers can comprise a silica-based matrix and can be obtained from precursors such as silicon alkoxides Si(OR)₄, The sol-gel layers then correspond to silica glasses.

The deposition can be carried out according to one of the following techniques:
dip coating;
spin coating;
laminar-flow coating or meniscus coating;
spray coating;
soak coating;
roll-to-roll processing;
paint coating;
screen printing.

The deposition is preferably carried out by spraying with air atomization. The temperature for drying the sol-gel layer can vary from 0° C. to 200° C., preferably from 100° C. to 150° C. and more preferably from 120° C. to 170° C.

The layers deposited by a sol-gel process provide a planarization of the surface of the layered element. However, when use is made of such planarization layers, the main external surface of the sol-gel layer can exhibit certain large-scale surface irregularities. In order to re-establish the smooth nature of the external layer of the layered element, it is thus possible to position, in contact with this surface exhibiting certain irregularities, several additional layers having substantially the same refractive index as said external layer, such as a plastic sheet and a flat glass substrate.

Another example of an external layer can be obtained by deposition of an enamel based on a glass frit on a glass substrate, for example a soda-lime glass substrate. In order to obtain the enamel, a formulation comprising a glass frit is first of all prepared by grinding the glass to particle sizes of a few microns (for example D50=2 microns), followed by forming a paste of this ground glass using an organic matrix. A layer of this composition is then deposited on the glass substrate by a liquid-route deposition technique, such as screen printing or slot coating. Finally, this layer is fired at a temperature higher by at least 100° C. with respect to the glass transition temperature of the glass frit used in the composition. The enamel layer corresponds to a layer based on curable materials initially in a viscous liquid or pasty state suitable for shaping operations.

The enamel layer can subsequently be rendered rough or textured by attack in solutions having extreme pH values, that is to say either strongly acidic (pH<2) or strongly basic (pH>12). In this case, it is considered that the glass substrate is an additional layer of the layered element and the enamel layer constitutes the external layer of the layered element.

The enamel layer can also be used as upper external layer. In this case, the textured upper external layer of the layered element can be composed simply of an enamel composition based on glass frit deposited by a liquid-route deposition technique (such as screen printing or slot coating) on a support precoated with a lower external layer and with a central layer. The enamel layer will “fill in” the roughness of the central layer. This layer comprises a surface matching the surface roughness of the central layer, which is thus textured, and a main external surface opposite this surface which is flat. However, in this case, from the viewpoint of the high firing temperatures in order to melt the composition comprising the glass frit, it is necessary to make sure that the materials employed for the other layers of the layered element, that is to say the materials of the external layer coated with the central layer, are capable of not deforming subsequent to this firing stage. For example, if use is made of a support composed of a glass substrate comprising a textured enamel as lower external layer, it is preferable for the enamel composition comprising the glass frit intended to form the upper external layer to exhibit a glass transition temperature Tg which is lower than the glass transition temperature of the frit composition used to form the enamel of the lower external layer. Thus, the lower external layer is not deformed during the stage of firing the upper external layer.

The external layer can comprise a layer based on an insert or sheet made of thermoformable or pressure-sensitive plastic textured by compression and/or heating. This layer based on polymer material can in particular be a layer based on polyvinyl butyral (PVB), on ethylene/vinyl acetate (EVA), on polyurethane (PU), on polyethylene terephthalate (PET) or on polyvinyl chloride (PVC). This layer based on polymer material can act as a laminating insert providing a connection with an additional layer, such as a transparent substrate with a refractive index substantially equal to that of the first external layer.

The thickness of the external layer is preferably between 0.2 μm and 6 mm, better still between 1 μm and 6 mm, and varies according to the choice of the material.

The flat or textured glass substrates preferably have a thickness of between 0.4 and 6 mm, preferably 0.7 and 4 mm.

The flat or textured polymer substrates preferably have a thickness of between 0.020 and 2 mm, preferably 0.025 and 0.25 mm.

The external layers composed of a layer of transparent material, preferably dielectric material, chosen from oxides, nitrides or halides of one or more transition metals, nonmetals or alkaline earth metals, preferably have a thickness of between 0.2 and 20 μm, preferably 0.5 and 2 μm.

The layers based on curable materials initially in a liquid or pasty viscous state suitable for shaping operations preferably have a thickness of between 0.5 and 50 μm, preferably between 0.5 and 20 μm. The layers based on photocrosslinkable and/or photopolymerizable materials preferably have a thickness of between 0.5 and 20 μm, preferably 0.7 and 10 μm. The layers deposited by a sol-gel process preferably have a thickness of between 0.5 and 50 μm, preferably between 10 and 15 μm. The enamel layers based on glass frit preferably have a thickness of between 3 and 30 μm, preferably 5 and 20 μm.

The layers based on a plastic insert or sheet preferably have a thickness of between 10 μm and 2 mm, preferably of between 0.3 and 1 mm.

The transparent materials or transparent layers used as external layer can have a refractive index of between 1.49 and 1.7, preferably of between 1.49 and 1.54 or of between 1.51 and 1.53, for example in the case of the use of a standard glass.

The quality of a screen composed of a glazing depends on the transmission and reflection properties of the glazing. As a general rule, the lower the light transmission, the higher the light reflection, and the better the quality of a screen used in direct projection. However, according to the invention, the retention of a good transparency in transmission is sought.

According to one embodiment, the central layer comprises at least one reflecting layer which promotes the reflection of light, that is to say a layer exhibiting a high reflection of visible radiation. This property, combined with the specific structure of the layered element, makes possible a diffuse reflection of the light, resulting in excellent properties for use as projection screen. However, the use of a reflecting layer is carried out to the detriment of the light transmission through the glazing, Consequently, the choice of the reflection and transmission properties of the central layer has to be made as a function of the expectations between a good transparency of the glazing and the achievement of a good luminosity of the projected image.

The layer or the stack of layers of the central layer of the layered element can comprise:
at least one adhesive layer made of transparent polymer,
at least one thin layer composed of a transparent material, preferably a dielectric material, chosen from oxides, nitrides or halides of one or more transition metals, nonmetals or alkaline earth metals,
at least one thin metallic layer, in particular a thin layer of silver, gold, copper, titanium, niobium, silicon, aluminum, nickel-chromium alloy (NiCr), stainless steel or their alloys.

The thin layer composed of a transparent material, preferably a dielectric material, can be chosen from:
at least one thin layer composed of a transparent material, preferably a dielectric material, having a high refractive index different from the refractive index of the external layers, such as Si₃N₄, AlN, NbN, SnO₂, ZnO, SnZnO, Al₂O₃, MoO₃, NbO, TiO₂ or ZrO₂,
at least one thin layer composed of a transparent material, preferably a dielectric material, having a low refractive index different from the refractive index of the external layers, such as SiO₂, MgF₂ or AlF₃.

When the central layer is an adhesive layer made of transparent polymer, the external layers are assembled together by means of this central layer formed by a layer of dielectric material with a different refractive index from that of the external layers.

The choice of the thickness of the central layer depends on a certain number of parameters. Generally, it is considered that the total thickness of the central layer is less than 1 μm, preferably between 5 and 200 nm, and the thickness of a layer of the central layer is between 1 and 200 nm.

When the central layer comprises a metallic layer, the thickness of a layer is preferably between 5 and 40 nm, better still between 6 and 30 nm and even better still from 6 to 20 nm. Preferably, the central layer comprises a metallic layer based on silver, gold, nickel, chromium or metal alloy, for example made of steel, preferably stainless steel.

When the central layer comprises a dielectric layer, for example of TiO₂, it preferably exhibits a thickness of between 20 and 100 nm and better still 55 and 65 nm and/or a refractive index of between 2.2 and 2.4.

Advantageously, the composition of the central layer of the layered element can be adjusted in order to confer additional properties on the layered element, for example thermal properties, of solar control and/or low emissivity type. Thus, in one embodiment, the central layer of the layered element is a transparent stack of thin layers comprising an alternation of “n” metallic functional layers, in particular of functional layers based on silver or silver-comprising metal alloy, and of “(n+1)” antireflection coatings, with n≧1 where each metallic functional layer is positioned between two antireflection coatings.

In a known way, such a stack having a metallic functional layer exhibits reflection properties in the range of solar radiation and/or in the range of long-wavelength infrared radiation. In such a stack, the metallic functional layers essentially determine the thermal performance, while the antireflection coatings which frame them act interferentially on the optical aspect. This is because, while the metallic functional layers make it possible to obtain the desired thermal performance even at a low geometrical thickness, of the order of 10 nm for each metallic functional layer, they are, however, strongly opposed to the passage of radiation in the range of visible wavelengths. Consequently, antireflection coatings on either side of each metallic functional layer are necessary to ensure good light transmission in the visible range. In practice, it is the overall stack of the central layer, comprising the thin metallic layers and the antireflection coatings, which is optimized optically. Advantageously, the optical optimization can be carried out on the overall stack of the layered element, that is to say including the external layers positioned on either side of the central layer.

The layered element obtained then combines optical properties, namely properties of specular transmission and diffuse reflection of an incident radiation on the layered element, and thermal properties, namely properties of solar control and/or low emissivity. The glazing comprising such an element comprises, in addition to its function of projection or back-projection screen, a function of solar protection and/or thermal insulation of buildings or vehicles.

When the central layer is an adhesive layer made of transparent polymer, the external layers are assembled together by means of this central layer formed by a layer of dielectric material with a different refractive index from that of the external layers.

According to one aspect of the invention, the texture of each contact surface between two adjacent layers of the layered element, one of which is transparent, preferably dielectric, and the other metallic or which are two transparent layers with different refractive indices, is formed by a plurality of patterns recessed or projecting with respect to a general plane of the contact surface. Preferably, the mean height of the patterns of each contact surface between two adjacent layers of the layered element, one of which is transparent, preferably dielectric, and the other metallic or which are two transparent layers with different refractive indices, is between 1 micrometer and 1 millimeter. Within the meaning of the invention, the mean height of the patterns of the contact surface is defined as the arithmetic mean of the distances yᵢ in absolute value, taken between the peak and the general plane of the contact surface for each pattern of the contact surface, equal to

$$\frac{1}{n} {\sum }_{i = 1}^{n} \vert {y}_{i} \vert .$$

The patterns of the texture of each contact surface between two adjacent layers of the layered element, one of which is transparent, preferably dielectric, and the other metallic or which are two transparent layers with different refractive indices, can be distributed randomly over the contact surface. In an alternative form, the patterns of the texture of each contact surface between two adjacent layers of the layered element, one of which is transparent and the other metallic or which are two transparent layers with different refractive indices, can be distributed periodically over the contact surface. These patterns can in particular be cones, pyramids, grooves, ribs or wavelets.

According to one aspect of the invention, for each layer of the central layer which is framed by layers having a nature, dielectric or metallic, different from its own or having refractive indices different from its own, the thickness of this layer, taken perpendicularly to its contact surfaces with the adjacent layers, is low with respect to the mean height of the patterns of each of its contact surfaces with the adjacent layers. Such a low thickness makes it possible to increase the probability that the entry interface of a radiation into this layer and the departure interface of the radiation out of this layer are parallel and thus to increase the percentage of specular transmission of the radiation through the layered element. Advantageously, the thickness of each layer of the central layer which is inserted between two layers having a nature, dielectric or metallic, different from its own or having refractive indices different from its own, where this thickness is taken perpendicularly to its contact surfaces with the adjacent layers, is less than ¼ of the mean height of the patterns of each of its contact surfaces with the adjacent layers.

The central layer is formed either by a single layer deposited conformably on the textured main surface of the first external layer or by a stack of layers successively deposited conformably on the textured main surface of the first external layer.

According to the invention, it is considered that the central layer is deposited conformably on the textured main surface of the first external layer if, subsequent to the deposition, the upper surface of the central layer is textured and parallel to the textured contact surface of the first external layer. The deposition of the central layer conformably or of the layers of the central layer conformably in succession on the textured main surface of the first external layer is preferably carried out by cathode sputtering, in particular magnetic-field assisted cathode sputtering.

The transparent layered element can extend over the entire surface of the glazing or over at least a portion of the glazing, that is to say that the layered element 1 can be formed or be present taking into account a portion only or the whole of the main external surfaces 10 and 20. The glazing can thus comprise the layered element over a portion only of its surface. Consequently, only the portion of the glazing comprising the layered element can actually be used as projection screen. The surface of the glazing which can actually be used as projection screen corresponds to and is aligned with the surface comprising the layered element. The term “a portion of the surface” is understood to mean a surface area sufficient to make possible the projection of an image viewable by an observer. By way of example, this portion of the surface can represent from 10% to 90% of the total surface area of the glazing.

In order to obtain a glazing homogeneous in thickness despite the absence of the layered element, several solutions are envisaged. According to one embodiment, use is made, as external layer, of a transparent substrate comprising a smooth main external surface and a main internal surface comprising at least a portion of its surface textured and at least a portion of its surface smooth. A central layer is subsequently deposited, for example by cathode sputtering, on the external layer. This deposition technique is in accordance with the surface. Consequently, a central layer textured solely on the textured portions of the external layer and a layer smooth on the nontextured portions of the external layer is obtained. Finally, an external layer based on curable materials initially in a liquid or pasty viscous state suitable for shaping operations, preferably a sol-gel layer, is deposited on the central layer. This layer will fill in the roughness when the central layer is textured and will planarize in all cases the upper main external surface of this assembly.

By proceeding in this way, the layered element of the invention, exhibiting in particular the characteristic of having at least two contact surfaces between two textured and parallel adjacent layers, is located only over the portions of the surface of the glazing which correspond with the textured portions of the external layer. The portions of the surface of the glazing which correspond with the smooth portions of the external layer do not exhibit a contact surface between two textured and parallel adjacent layers and consequently do not exhibit a diffuse reflection property. A glazing comprising the layered element only over a portion only of the surface of the glazing of the invention is thus indeed obtained.

The partial texturing of a substrate can be obtained by any known texturing process as described above, for example by embossing the surface of the substrate, by abrasion, by sandblasting, by chemical treatment or by engraving, for example using masks to keep at least a portion of the surface of the substrate nontextured.

This embodiment is advantageous as it is thus possible, for example, to obtain the layered element only over a banner of the top part of the glazing in order to project information thereon. Only the portion of the glazing comprising the layered element can actually be used as projection screen. This is possible in particular by virtue of the very high angle of view offered by this invention, which makes it possible to orientate the projector with a large angle.

According to one embodiment, the glazing additionally comprises at least one antireflection coating 6. The presence of an antireflection coating has the effect of favorably reflecting an incident radiation at each textured contact surface of the layered element rather than on the external surfaces of the glazing, which corresponds to a diffuse reflection mode rather than to a specular reflection mode. A diffuse reflection of the radiation by the layered element is thus favored in comparison with a specular reflection.

The presence of one or more antireflection coatings contributes to the achievement of a better definition of the projected image, in particular to the improvement in the sharpness of the image and to the increase in the contrast of the main image resulting from the projection, in comparison with the secondary images originating from multiple reflections.

The antireflection coating is preferably positioned on the main external surface of the glazing located on the side furthest from the projector, whether the screen is used as projection screen or back-projection screen. This is because, in order for the glazing to remain transparent, most of the light is transmitted through, whereas the other portion is reflected in diffuse manner in order to form this image. This major portion of the transmitted light can then be reflected by the main external surface of the glazing located on the side opposite the projector and can reform an image on the central layer which will then have a different size as a result of the longer distance traveled by the light. This double image damages the sharpness of the image.

The same phenomenon occurs on the other main external surface of the glazing located on the projector side but only starting from the fraction of the light reflected in diffuse manner and thus a weaker image.

The glazing advantageously comprises at least one antireflection coating on each of its main external surfaces.

By preferably increasing order, the glazing of the invention thus comprises:
at least one antireflection coating at the interface between the air and the constituent material of the layer forming the main external surface of the glazing, preferably on the opposite side of the glazing with respect to the projector,
at least one antireflection coating on each of the main external surfaces of the glazing.

When the glazing comprises a substrate (or counter-substrate), the external surface of which corresponds to the main external surface of the glazing, the antireflection coating can occur on the external surface and/or on the internal surface of the substrate.

The antireflection coating provided on at least one of the main external surfaces of the glazing can be of any type which makes it possible to reduce the reflection of radiation at the interface between the air and the support on which it is deposited, such as a glass substrate or the external layer of the layered element. It can in particular be a layer with a refractive index between the refractive index of air and the refractive index of the support on which it is deposited, such as a layer deposited by a vacuum technique or a porous layer of sol-gel type or also, in the case where the external layer is made of glass, a hollowed-out surface portion of the external glass layer obtained by an acid treatment of etching type. In an alternative form, the antireflection coating can be formed by a stack of thin layers having alternately lower and higher refractive indices which acts as an interference filter at the interface between the air and the external layer or by a stack of thin layers exhibiting a continuous or staggered gradient of refractive indices between the refractive index of air and that of the external layer.

The additional layers are preferably chosen from:
transparent substrates chosen from polymers, glasses or ceramics as defined above but comprising two smooth main surfaces,
curable materials initially in a liquid or pasty viscous state suitable for shaping operations as described above,
inserts or sheets made of thermoformable or pressure-sensitive plastic as described above.

Advantageously, the smooth main external surfaces of the layered element and/or the smooth main external surfaces of the glazing are flat or curved; preferably, these smooth main external surfaces are parallel to one another. This contributes to limiting the light dispersion for a radiation crossing the layered element and thus to improving the sharpness of the viewing through the layered element or the glazing.

Another subject matter of the invention is a projection system comprising a glazing used as projection screen as defined in the present patent application and a projector provided for illuminating the glazing in projection.

Another subject matter of the invention is the glazing used as projection or back-projection screen according to the invention comprising two main external surfaces 10, 20 exhibiting the characteristics described in the present patent application in relation to the glazing.

The glazing is preferably used as a projection screen operating in reflection, that is to say that the spectators and the projector are located on the same side of the glazing used as projection screen. The glazing can, however, be used as a back-projection screen operating in transmission, that is to say that the spectators and the projector are located on each side of the glazing.

Said glazing preferably comprises at least one transparent layered element 1 as defined above and at least one variable scattering system.

According to an advantageous embodiment of the invention, the glazing additionally comprises an electrically controllable variable light scattering system. The functional film comprises active elements, the orientation of which is modified by application of an electric or magnetic field.

These variable light scattering systems comprise, for example, liquid-crystal systems.

According to the invention, the term “ON state” is understood to mean the transparent state of the functional film when the glazing is supplied with electricity and the term “OFF state” is understood to mean the scattering state of the functional film when the glazing is no longer supplied with electricity. The active elements, when the film is placed under voltage, become oriented along a favored axis, which makes it possible for a radiation to be transmitted and thus allows viewing through the functional film. Without voltage, in the absence of alignment of the active elements, the film becomes scattering and prevents viewing. The functional film alternates reversibly between a transparent state and a translucent state by application of an electric field.

The combination of a transparent layered element having diffuse reflection properties and of a variable light scattering system makes it possible to switch between a transparent state and a scattering state. The combination of the properties in reflection of the variable light scattering system in the scattering state and of the transparent element having diffuse reflection makes it possible to obtain a projection screen exhibiting an excellent luminosity, a high contrast and a greater angle of view, in comparison with a glazing comprising a variable light scattering system used alone.

Finally, when the variable light scattering system is in the transparent state, due to the presence of the transparent layered element having diffuse reflection, the glazing can all the same act as projection screen in direct projection.

According to the invention, it is possible to project images having good qualities in illuminated environments, whereas this was difficult for the glazings of the prior art comprising variable light scattering systems. The quality of the images projected is very greatly improved, in particular the contrast, without harming the transparency of the glazing when the functional film is in the ON state.

This advantageous embodiment thus makes it possible, in comparison with a glazing comprising only a variable light scattering system, to increase the luminosity and the contrast, both in the penumbra and in an illuminated room, and to obtain excellent angles of view and consequently good viewing and readability of the image, even when observing it with an angle of 180°.

The electrically controllable variable light scattering systems having liquid crystals comprise a functional film comprising liquid crystals. These liquid-crystal systems reversibly alternate, by application of an electric field, preferably an alternating electric field, between a transparent state and a nontransparent state. The functional film preferably comprises a polymeric material in which droplets of liquid crystals, in particular nematic liquid crystals having a positive dielectric anisotropy, are dispersed.

The liquid crystals used for glazing applications preferably come within the family of the calamitic liquid crystals. This family of liquid crystals is generally divided into three groups: nematic, cholesteric and smectic.

For large-surface-area applications, the terms used are generally dispersed liquid crystals (PDLC, Polymer-Dispersed Liquid Crystals) and encapsulated liquid crystals (NCAP, Nematic Curvilinear Aligned Phase), in particular those used in Priva-Lite® glazings. These systems result from nematic liquid crystals enclosed in microcavities. The NCAP films are generally prepared starting from an emulsion, while the PDLC films generally result from an isotropic solution which forms separate phases during the polymerization or crosslinking.

Use may also be made, according to the invention, of liquid crystals of CLC (“Cholesteric Liquid Crystal”) or NPD-LCD (“Non-homogeneous Polymer Dispersed Liquid Crystal Display”) type.

Use may also be made, for example, of a layer comprising a gel based on cholesteric liquid crystals comprising a small amount of crosslinked polymer, such as those described in the patent WO-92/19695, or liquid crystals which switch with variation in light transmission LT. More broadly, the choice may thus be made of PSCT (“Polymer Stabilized Cholesteric Texture”) products.

Use may also be made of bistable liquid crystals, such as described in the patent EP 2 256 545, which switch under the application of an alternating electric field in the pulsed form and which remain in the switched state until the application of a fresh pulse.

The functional film comprising the liquid crystals preferably has a thickness of between 3 and 100 μm, preferably 3 to 50 μm and better still 3 to 30 μm.

The functional film can comprise a polymer film in which liquid crystals are dispersed as active elements or a layer of liquid crystals. The polymer film can be a crosslinked polymer film or an emulsion of liquid crystals in a medium. The liquid crystals known under the terms of NCAP, PDLC, CLC and NPD-LCD can be used.

The functional film can be a polymer film which comprises, as active elements, liquid crystals dispersed in the form of droplets in an appropriate medium. The liquid crystals can be nematic liquid crystals having a positive dielectric anisotropy, such as liquid crystals of the NCAP or PDLC type. Examples of liquid-crystal functional film are described in particular in the European patents EP-88 126, EP-268 877, EP-238 164, EP-357 234, EP-409 442 and EP-964 288 and the United States patents U.S. Pat. No. 4,435,047, U.S. Pat. No. 4,806,922 and U.S. Pat. No. 4,732,456.

These polymer films can be obtained by evaporation of the water present in an aqueous emulsion of liquid crystals and of a medium comprising a water-soluble polymer.

The medium is preferably based on a polymer of the family of the latexes of polyurethane (PU) type and/or on a polymer of polyvinyl alcohol (PVA) type generally prepared in the aqueous phase in a proportion of polymers of 15% to 50% by weight, with respect to the water.

As a general rule, the birefringence of the liquid crystals is between 0.1 and 0.2 and varies in particular as a function of the medium used, Their birefringence is of the order of 0.1, if the polymer of the medium is of polyurethane (PU) type, and of the order of 0.2, if it is of polyvinyl alcohol (PVA) type.

The elements active with regard to light scattering are advantageously in the form of droplets having a mean diameter of between 0.5 and 3 μm, in particular between 1 and 2.5 μm, dispersed in the medium. The size of the droplets depends on a certain number of parameters, including in particular the emulsifiability of the active elements in the medium under consideration. Preferably, these droplets represent between 120% and 220% by weight of the medium, in particular between 150% and 200% by weight, excluding the solvent, generally aqueous, of said medium.

Particularly preferably, the choice is made of liquid crystals in the form of droplets having a diameter of approximately 2.5 μm, when the medium is based on polyurethane latex (birefringence of approximately 0.1), and having a diameter of approximately 1 μm, when the medium is instead based on polyvinyl alcohol (birefringence of approximately 0.2).

A functional film comprising a liquid emulsion of nematic liquid crystals preferably comprises a thickness of approximately 10 to 30 μm, better still of 20 to 25 μm.

This type of film, once laminated and incorporated between two substrates, is sold by Saint-Gobain Glass under the Priva-Lite® trade name.

A polymer film comprising liquid crystals can be obtained by preparation of a mixture comprising liquid crystals, monomers and preferably a polymerization initiator, followed by the crosslinking of the monomers.

The polymer film comprising the liquid crystals can comprise compounds, such as the compound 4-((4-ethyl-2,6-difluorophenyl)ethynyl)-4′-propylbiphenyl and 2-fluoro-4,4′-bis(trans-4-propylcyclohexyl)biphenyl, for example sold by Merck under the reference MDA-00-3506.

The polymer film can comprise the known compounds described in the document U.S. Pat. No. 5,691,795. Mention may be made, as liquid crystals suitable according to the invention, of the product from Merck Co. Ltd sold under the trade name “E-31 LV”, which corresponds to a mixture of several liquid crystal compounds. Preferably, use is made of a mixture of this product with a chiral substance, for example 4-cyano-4′-(2-methylbutyl)biphenyl, a monomer, for example 4,4′-bisacryloylbiphenyl, and a UV photoinitiator, for example benzoin methyl ether (CAS No. 3524-62-7). This mixture is applied in the “layer” form in contact with the electrode. After curing the polymer film comprising the liquid crystals by irradiation with UV light, a polymer network is formed in which the liquid crystals are incorporated.

A polymer film comprising a polymer network in which the liquid crystals are incorporated can have a thickness ranging from 3 to 100 μm, preferably from 3 to 60 μm and better still from 3 to 20 μm.

According to another embodiment, the layer of liquid crystals comprises liquid crystals and spacers. The spacers can be made of glass, such as glass beads, or made of hard plastic, for example made of polymethyl methacrylate (PMMA). These spacers are preferably transparent and preferably exhibit an optical index which is substantially equal to the optical index of the matrix of the layer of liquid crystals. The spacers are made of non-conducting material.

The layer of liquid crystals does not necessarily comprise polymer constituting a medium or a network. This layer can be composed solely of the liquid crystals and spacers. The liquid crystals are applied (without additional monomer) over a thickness of 3 to 60 μm, preferably of 3 to 20 μm, in contact with the electrode. Compounds suitable for this embodiment are described, for example, in the document U.S. Pat. No. 3,963,324. According to this embodiment, the thickness of the layer of liquid crystals can be between 10 and 30 μm, preferably 10 and 20 μm.

The variable light scattering system comprising the functional film can extend over the entire surface of the glazing or over at least a portion of the glazing. When the variable light scattering system extends over at least a portion of the glazing, this portion of the surface corresponds to and is aligned with the portion of the surface of the glazing comprising the layered element. The variable light scattering system can thus be formed or be present taking into account a portion only or the whole of the main external surfaces 10, 20 of the glazing.

The functional film is preferably framed by two electrode-carrying supports, the electrodes being in direct contact with the functional film.

The electrodes each comprise at least one electrically conducting layer. The electrically conducting layer can comprise transparent conductive oxides (TCO), that is to say materials which are both good conductors and transparent in the visible region, such as tin-doped indium oxide (ITO), antimony-doped tin oxide, fluorine-doped tin oxide (SnO₂: F) or aluminum-doped zinc oxide (ZnO:Al). An electrically conducting layer based on ITO exhibits a resistance of approximately 100 ohms per square.

The electrically conducting layer can also comprise transparent conductive polymers which are organic compounds comprising conjugated double bonds, the conductivity of which can be improved by chemical or electrochemical doping.

These electrically conducting layers based on conductive oxides or conductive polymers are preferably deposited over thicknesses of the order of 50 to 100 nm, directly on the functional film or on an intermediate layer, by a large number of known techniques, such as magnetic-field assisted cathode sputtering, evaporation, the sol-gel technique and vapor phase deposition (CVD) techniques.

The electrically conducting layer can also be a metallic layer, preferably a thin layer or a stack of thin layers, referred to as TCC (Transparent Conductive Coating), for example made of Ag, Al, Pd, Cu, Pd, Pt, In, Mo or Au, and typically with a thickness between 2 and 50 nm.

The electrodes comprising an electrically conducting layer are connected to an energy supply. The energy supply can be an electrical supply using voltages of between 0 and 110 V. Two electrical wires each comprising a wiring input are connected to a separate electrode connection.

The electrically conducting layers of the electrodes can then be deposited directly on a face of a support and thus form the electrode-carrying supports.

The supports can be glass sheets, for example flat float glass sheets, or plastic inserts. The plastic sheets can in particular be sheets made of thermoplastic polymer of the PVB (polyvinyl butyral) or EVA (ethylene/vinyl acetate) type, polyurethane (PU) or sheets made of polyethylene terephthalate (PET).

The PET sheets have, for example, a thickness of between 50 μm and 1 mm, preferably of between 100 and 500 μm, better still of between 150 and 200 μm, in particular of approximately 175 μm.

The variable light scattering system can thus comprise two electrode-carrying supports each composed of a PET sheet covered with an electrically conducting ITO layer framing a functional film.

A variable light scattering system of this type is used in the Priva-Lite® glazings from Saint-Gobain Glass.

Preferably, use is made of a glass sheet exhibiting a thickness of at least 3 mm, when the thickness of the functional film is less than 30 μm, and a glass sheet exhibiting a thickness of at least 2 mm, when the thickness of the functional film is greater than or equal to 30 μm.

The variable light scattering system can thus comprise two electrode-carrying supports comprising a flat float glass sheet comprising an electrode comprising an electrically conducting layer framing a functional film.

The layered element can be a rigid glazing or a flexible film. Such a flexible film is advantageously provided, on one of its main external surfaces, with an adhesive layer covered with a protective strip intended to be removed for the adhesive bonding of the film. The layered element in the form of a flexible film is then suitable for being added by adhesive bonding to an existing surface, for example a surface of a glazing, in order to confer, on this surface, diffuse reflection properties, while maintaining specular transmission properties.

In a preferred embodiment of the invention, the lower external layer is a transparent substrate. The central layer is formed either by a single layer deposited conformably on the textured main surface of the first external layer or by a stack of layers successively deposited conformably on the textured main surface of the first external layer. Preferably, the central layer is deposited by cathode sputtering, in particular magnetic-field assisted cathode sputtering. The second external layer or upper external layer comprises a sol-gel layer deposited on the textured main surface of the central layer opposite the first external layer.

According to another aspect of the invention, one or more upper additional layers can be used, such as an insert or sheet made of thermoformable or pressure-sensitive plastic and/or a transparent substrate or a counter-substrate. The layer based on a plastic insert or sheet then corresponds to a laminating insert providing the connection or integrality between the upper external layer of the layered element preferably comprising the sol-gel layer and the additional layer preferably comprising the counter-substrate.

The glazing of the invention preferably comprises the following stack:
optionally at least one lower additional layer chosen from transparent substrates, the two main surfaces of which are smooth, such as polymers and glasses and inserts made of thermoformable or pressure-sensitive plastic,
a lower external layer chosen from transparent substrates, such as polymers and glasses, inserts made of thermoformable or pressure-sensitive plastic, and curable materials initially in a liquid or pasty viscous state suitable for shaping operations,
a central layer comprising a thin layer composed of a transparent material, preferably a dielectric material, or a thin metallic layer,
an upper external layer chosen from sol-gel layers,
optionally at least one upper additional layer chosen from transparent substrates, the two main surfaces of which are smooth, chosen from polymers and glasses and inserts made of thermoformable or pressure-sensitive plastic.

In an alternative form of the invention, the glazing of the invention comprises the following stack:
a layered element comprising:
   a lower external layer chosen from transparent substrates made of rough glass,
   a central layer preferably comprising a thin layer,
   an upper external layer chosen from curable materials initially in a liquid or pasty viscous state suitable for shaping operations, preferably a sol-gel layer,
an insert made of thermoformable or pressure-sensitive plastic,
a transparent substrate made of flat glass preferably comprising at least one antireflection coating.

In this embodiment, the glazing comprises an upper additional layer chosen from inserts of thermoformable or pressure-sensitive material, on which another upper additional layer chosen from transparent glass substrates is preferably superimposed.

In another alternative form of the invention, the glazing of the invention comprises the following stack:
a layered element,
an insert made of thermoformable or pressure-sensitive plastic,
a variable light scattering system comprising a functional film framed by two electrode-carrying supports, said electrodes being directly in contact with the functional film,
an insert made of thermoformable or pressure-sensitive plastic,
a transparent substrate made of flat glass preferably comprising at least one antireflection coating.

Another subject matter of the invention is a process for the manufacture of a glazing comprising the layered element as described above and a variable light scattering system, comprising the following stages:

A) the layered element is manufactured:
a transparent substrate, one of the main surfaces of which is textured and the other main surface of which is smooth, is provided as first external layer or lower external layer;
a central layer is deposited on the textured main surface of the lower external layer, either, when the central layer is formed by a single layer, which is a transparent layer, preferably a dielectric layer, with a refractive index different from that of the lower external layer, or a metallic layer, by depositing the central layer conformably on said textured main surface, or, when the central layer is formed by a stack of layers comprising at least one transparent layer, preferably a dielectric layer, with a refractive index different from that of the lower external layer, or a metallic layer, by depositing the layers of the central layer conformably in succession on said textured main surface;
the second external layer or upper external layer is formed on the textured main surface of the central layer opposite the lower external layer, where the lower and upper external layers are composed of transparent materials, preferably dielectric materials, having substantially the same refractive index,
optionally at least one additional upper and/or lower layer is formed on the smooth main external surface or surfaces of the layered element,
   B) the layered element, optionally comprising additional layers, and a variable light scattering system are assembled.

The variable light scattering system and the layered element can be assembled by any known means, such as mechanical or chemical means. It is possible in particular to assemble them by laminating by virtue of the use of laminating insert.

Preferably, the deposition of the central layer conformably or of the layers of the central layer conformably in succession on the textured main surface of the first external layer is carried out by cathode sputtering, in particular magnetic-field assisted cathode sputtering.

According to one aspect of the invention, the second external layer is formed by depositing, on the textured main surface of the central layer opposite the first external layer, a layer which has substantially the same refractive index as the first external layer and which is provided initially in a viscous state suitable for shaping operations. The second external layer can thus be formed, for example, by a process comprising the deposition of a layer of photocrosslinkable and/or photopolymerizable material initially in the fluid form, followed by the irradiation of this layer, or by a sol-gel process.

According to another aspect of the invention, the second external layer is formed by positioning, against the textured main surface of the central layer opposite the first external layer, a layer based on polymer material having substantially the same refractive index as the first external layer and by then conforming this layer based on polymer material against the textured main surface of the central layer by compression and/or heating at least to the glass transition temperature of the polymer material.

The characteristics and advantages of the invention will become apparent in the description which will follow of several embodiments of a layered element, given solely by way of example and made with reference to the appended drawings, in which:

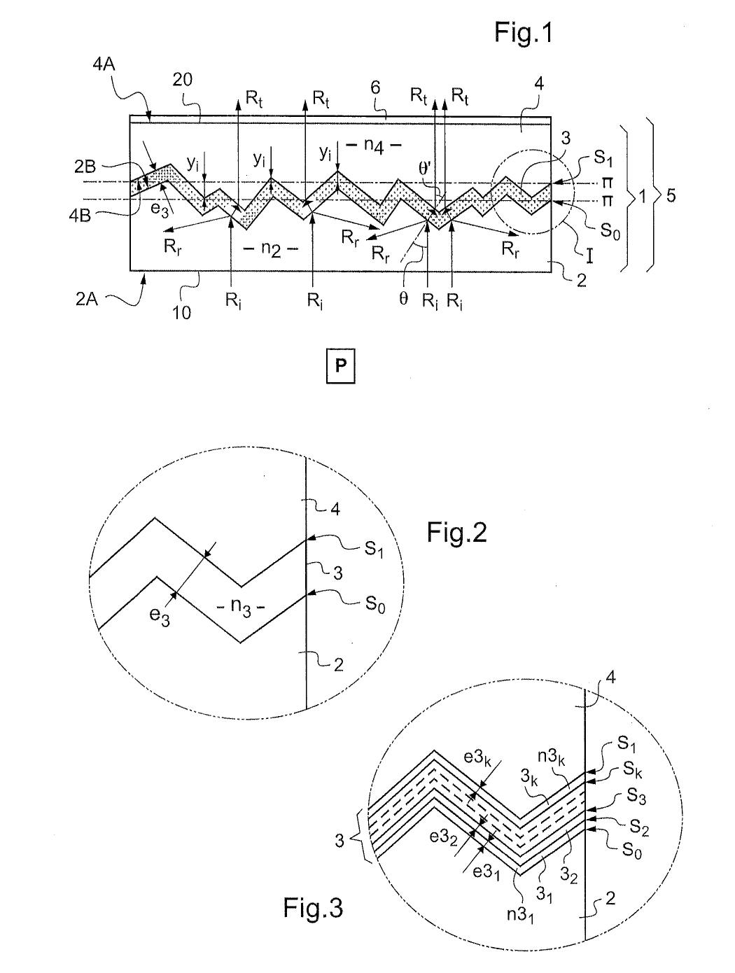

FIG. 1 is a diagrammatic transverse cross section of a projection system according to the invention comprising a projector and a glazing comprising the layered element in accordance with an embodiment according to the invention;

FIG. 2 is a view on a larger scale of the feature I of FIG. 1 for a first alternative form of the layered element;

FIG. 3 is a view on a larger scale of the feature I of FIG. 1 for a second alternative form of the layered element;

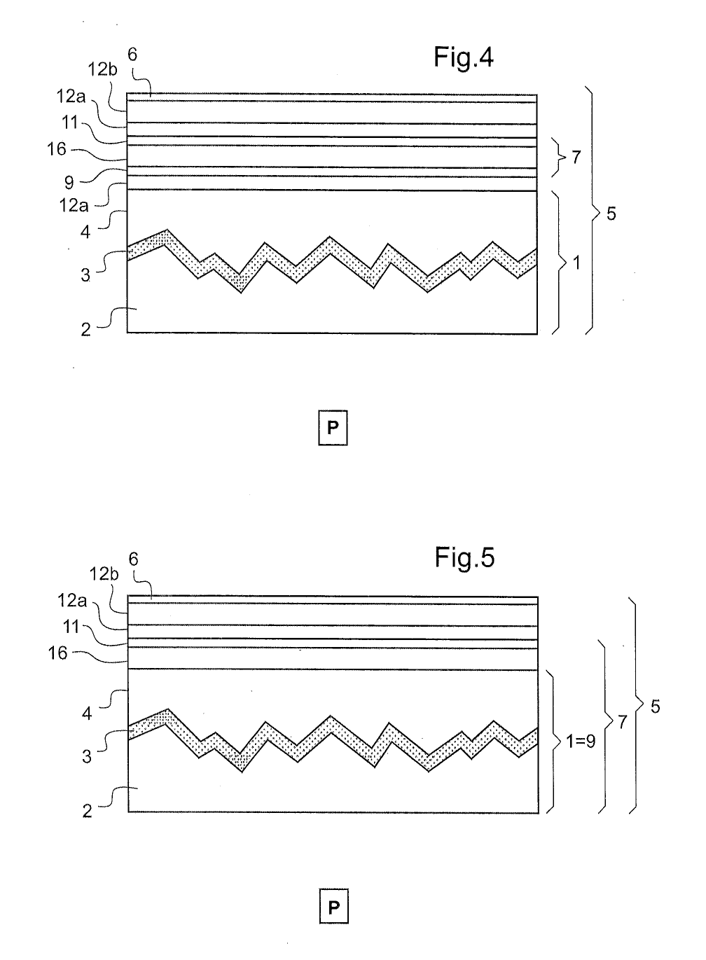

FIGS. 4 and 5 are two diagrammatic transverse cross sections of projection systems according to the invention comprising a projector and a glazing comprising the layered element and a variable light scattering system in accordance with preferred embodiments according to the invention;

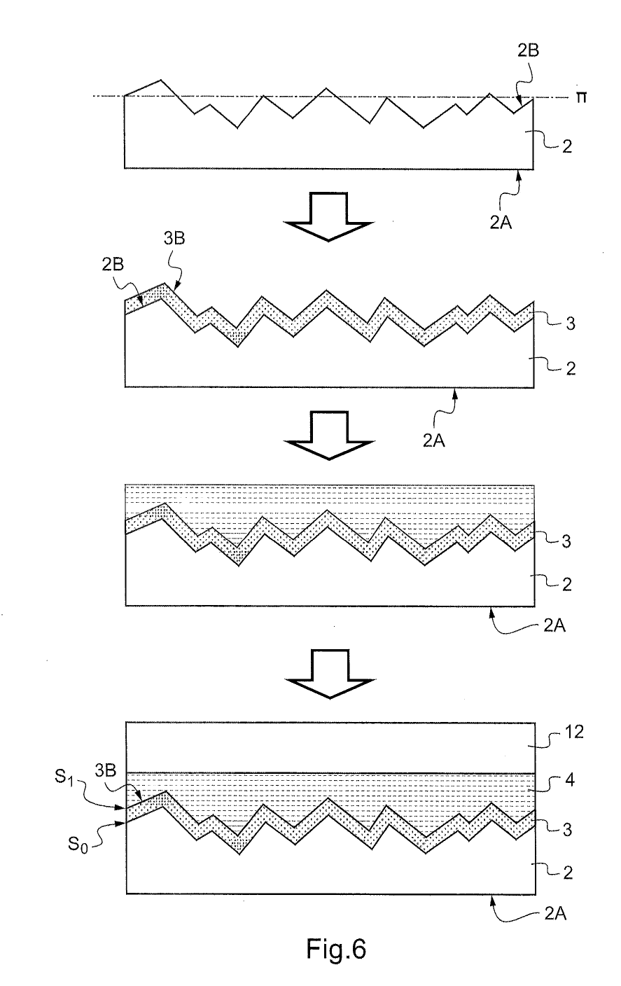

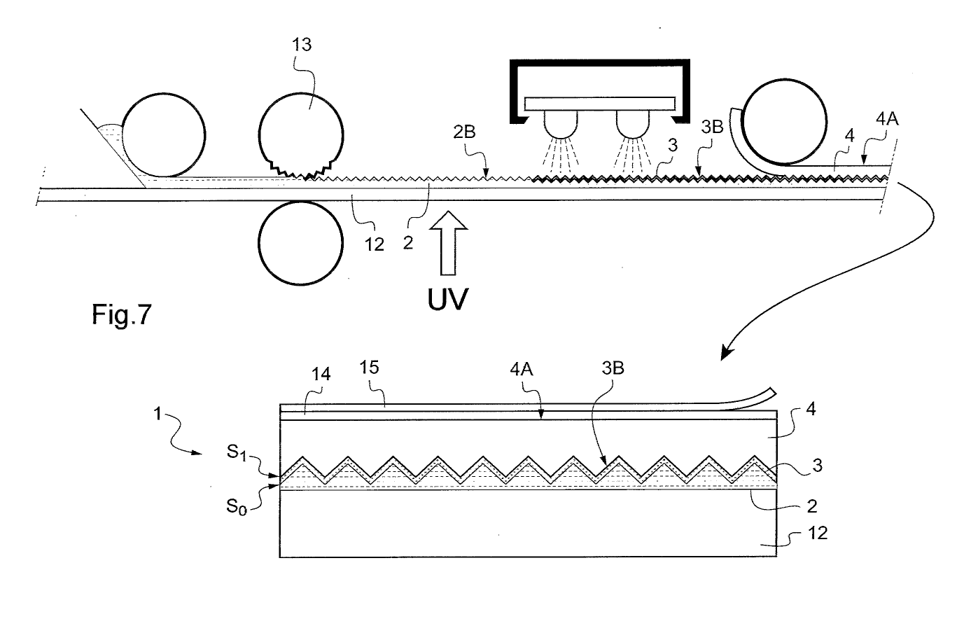

FIGS. 6 and 7 represent schemes showing the stages of a process for the manufacture of a glazing according to the invention; and

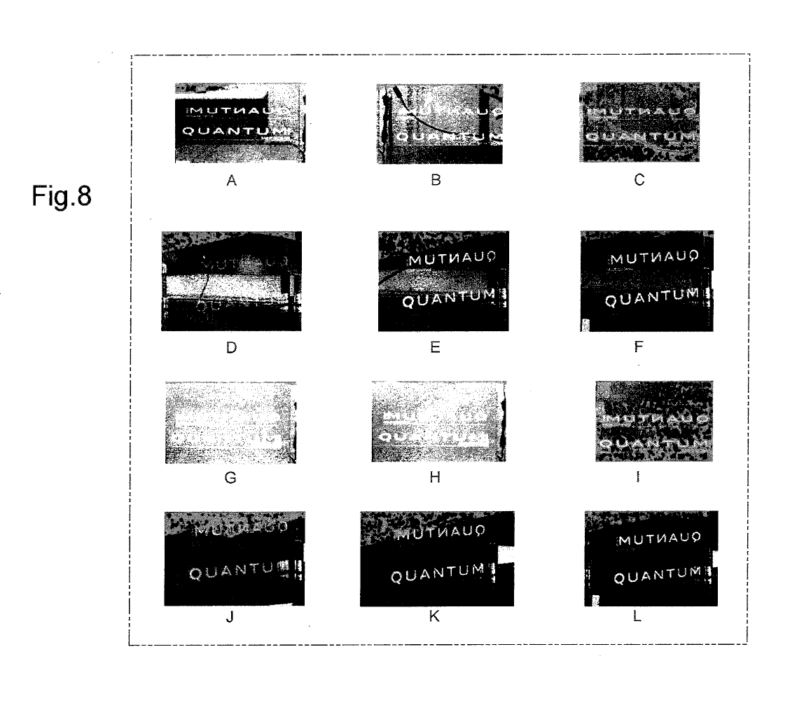

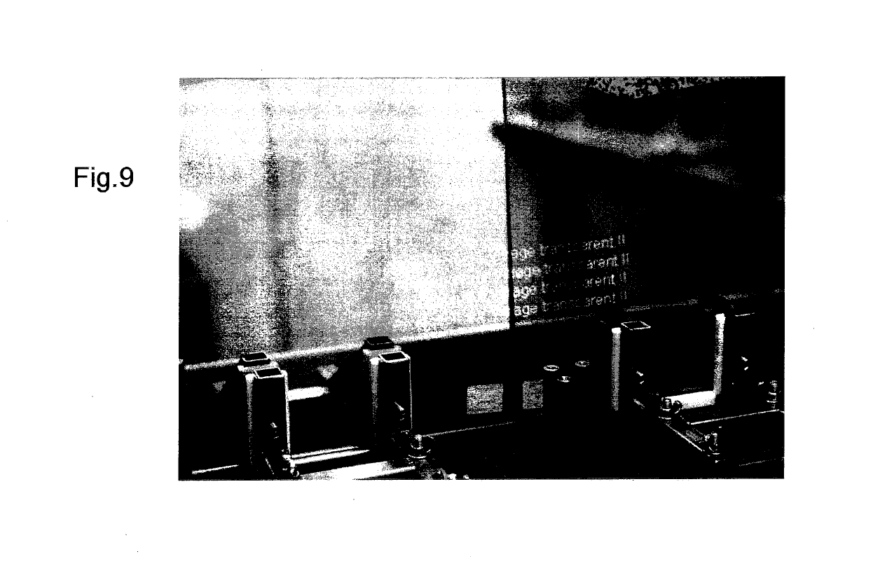

FIGS. 8 and 9 represent photographs.

For the clarity of the drawing, the relative thicknesses of the different layers in the figures have not been rigourously observed. Furthermore, the possible variation in thickness of the constituent layer or each constituent layer of the central layer as a function of the slope of the texture has not been represented in the figures, it being understood that this possible variation in thickness does not have an impact on the parallelism of the textured contact surfaces. This is because, for each given slope of the texture, the textured contact surfaces are parallel to one another.

FIG. 1 represents a projection system intended to operate in reflection comprising a projector P and a glazing 5 comprising a layered element 1. The glazing is used as projection screen, i.e. for a spectator located on the side of the projector P, rather than as back-projection screen, i.e. in which the projector is located behind the glazing, the spectator and the projector being separated by the glazing.

The glazing comprises two main external surfaces 10 and 20. The main external surface 10 represents the side of the glazing onto which images viewable by spectators are projected by virtue of the projector. The main external surface 20 represents the opposite side of the glazing with respect to the projector. As the glazing is being used as a projection screen operating in reflection, the spectators and the projector are located on the same side of the glazing.

The layered element 1 comprises two external layers 2 and 4 which are composed of transparent materials having substantially the same refractive index n2, n4. Each external layer 2 or 4 exhibits a smooth main surface, respectively 2A or 4A, directed toward the outside of the layered element, and a textured main surface, respectively 2B or 4B, directed toward the inside of the layered element.

The smooth external surfaces 2A and 4A of the layered element 1 make possible a specular transmission of radiation at each surface 2A and 4A, that is to say the entry of a radiation into an external layer or the departure of a radiation from an external layer without modifying the direction of the radiation.

The textures of the internal surfaces 2B and 4B are complementary to one another. As clearly visible in FIG. 1, the textured surfaces 2B and 4B are positioned facing one another, in a configuration where their textures are strictly parallel to one another. The layered element 1 also comprises a central layer 3 inserted in contact between the textured surfaces 2B and 4B.

In the alternative form shown in FIG. 2, the central layer 3 is a monolayer and is composed of a transparent material which is either metallic or transparent with a refractive index n3 different from that of the external layers 2 and 4. In the alternative form shown in FIG. 3, the central layer 3 is formed by a transparent stack of several layers 3₁, 3₂, . . . , 3ₖ, where at least one of the layers 3₁ to 3ₖ is either a metallic layer or a transparent layer, preferably a dielectric layer, with a refractive index different from that of the external layers 2 and 4. Preferably, at least each of the two layers 3₁ and 3ₖ located at the ends of the stack is a metallic layer or a transparent layer with a refractive index n3₁ or n3ₖ different from that of the external layers 2 and 4.

In FIGS. 1 to 3, S₀ marks the contact surface between the external layer 2 and the central layer 3 and S₁ marks the contact surface between the central layer 3 and the external layer 4. Furthermore, in FIG. 3, S₂ to Sₖ successively mark the internal contact surfaces of the central layer 3 starting from the contact surface closest to the surface S₀.

In the alternative form of FIG. 2, as a result of the arrangement of the central layer 3 in contact between the textured surfaces 2B and 4B, which are parallel to one another, the contact surface S₀ between the external layer 2 and the central layer 3 is textured and parallel to the contact surface S₁ between the central layer 3 and the external layer 4. In other words, the central layer 3 is a textured layer exhibiting, over its entire extent, a uniform thickness e3, taken perpendicularly to the contact surfaces S₀ and S₁.

In the alternative form of FIG. 3, each contact surface S₂, . . . , Sₖ between two adjacent layers of the constituent stack of the central layer 3 is textured and strictly parallel to the contact surfaces S₀ and S₁ between the external layers 2, 4 and the central layer 3. Thus, all the contact surfaces S₀, S₁, . . . , Sₖ between adjacent layers of the element 1 which are, on the one hand, either of different natures, transparent with a refractive index (n2, n4, n3, n3₁, n3₂, . . . or n3ₖ) or metallic, or, on the other hand, transparent with different refractive indices, are textured and parallel to one another. In particular, each layer 3₁, 3₂, . . . , 3ₖ of the constituent stack of the central layer 3 exhibits, at least locally, a uniform thickness e3₁, e3₂, e3ₖ, taken perpendicularly to the contact surfaces S₀, S₁, . . . , Sₖ.

As shown in FIG. 1, the texture of each contact surface S₀, S₁ or S₀, S₁, . . . , Sₖ of the layered element 1 is formed by a plurality of recessed or projecting patterns, with respect to a general plane π of the contact surface. Preferably, the mean height of the patterns of each textured contact surface S₀, S₁ or S₀, S₁, . . . , Sₖ is between 1 micrometer and 1 millimeter. The mean height of the patterns of each textured contact surface is defined as the arithmetic mean

$$\frac{1}{n} {\sum }_{i = 1}^{n} \vert {y}_{i} \vert ,$$

with yᵢ the distance taken between the peak and the plane π for each pattern of the surface, as shown diagrammatically in FIG. 1.

According to one aspect of the invention, the thickness e3 or e3₁, e3₂, . . . , eₖ of the constituent layer or each constituent layer of the central layer 3 is less than the mean height of the patterns of each textured contact surface S₀, S₁ or S₀, S₁, . . . , Sₖ of the layered element 1. This condition is important for increasing the probability that the entry interface of a radiation into a layer of the central layer 3 and the departure interface of the radiation out of this layer are parallel and thus for increasing the percentage of specular transmission of the radiation through the layered element 1. For the sake of viewability of the different layers, this condition has not been strictly observed in the figures.

Preferably, the thickness e3 or e3₁, e3₂, . . . , e3ₖ of the constituent layer or each constituent layer of the central layer 3 is less than ¼ of the mean height of the patterns of each textured contact surface of the layered element. In practice, when the central layer 3 is a thin layer or a stack of thin layers, the thickness e3 or e3₁, e3₂, e3ₖ of each layer of the central layer 3 is of the order of or less than 1/10 of the mean height of the patterns of each textured contact surface of the layered element.

FIG. 1 illustrates the route of a radiation which is incident on the layered element 1 on the side of the external layer 2. The incident rays Rᵢ arrive on the external layer 2 with a given angle of incidence θ. As shown in FIG. 1, the incident rays Rᵢ, when they reach the contact surface S₀ between the external layer 2 and the central layer 3, are reflected either by the metallic surface or as a result of the difference in refractive index at this contact surface respectively between the external layer 2 and the central layer 3, in the alternative form of FIG. 2, and between the external layer 2 and the layer 3₁, in the alternative form of FIG. 3. As the contact surface S₀ is textured, the reflection takes place in a plurality of directions Rᵣ. The reflection of the radiation by the layered element 1 is thus diffuse.

A portion of the incident radiation is also refracted in the central layer 3. In the alternative form of FIG. 2, the contact surfaces S₀ and S₁ are parallel to one another, which implies, according to the Snell-Descartes law, that n2.sin(θ)=n4.sin(θ′), where θ is the angle of incidence of the radiation on the central layer 3 starting from the external layer 2 and θ′ is the angle of refraction of the radiation in the external layer 4 starting from the central layer 3. In the alternative form of FIG. 3, as the contact surfaces S₀, S₁, . . . , Sₖ are all parallel to one another, the relationship n2.sin(θ)=n4.sin(θ′) resulting from the Snell-Descartes law remains confirmed. Consequently, in both alternative forms, as the refractive indices n2 and n4 of the two external layers are substantially equal to one another, the rays Rₜ transmitted by the layered element are transmitted with an angle of transmission θ′ equal to their angle of incidence θ on the layered element. The transmission of the radiation by the layered element 1 is thus specular.

Similarly, in both alternative forms, an incident radiation on the layered element 1 on the side of the external layer 4 is reflected in diffuse fashion and transmitted in specular fashion by the layered element, for the same reasons as above.

Advantageously, the layered element 1 comprises an antireflection coating 6 on at least one of its smooth main external surfaces of the glazing 10 and 20. The glazing of FIG. 1 does not comprise an additional layer. Consequently, the main external surfaces of the glazing 10 and 20 are coincident with the main external surfaces of the layered element 2A and 4A. Preferably, an antireflection coating 6 is provided on each main external surface of the glazing which is intended to receive a radiation. In the example of FIG. 1, only the surface 20 of the glazing is provided with an antireflection coating 6 as it concerns the surface of the glazing which is directed on the side opposite the projector.

As mentioned above, the antireflection coating 6 can be of any type which makes it possible to reduce the reflection of radiation at the interface between the air and the external layer. It can, in particular, be a layer with a refractive index between the refractive index of air and the refractive index of the external layer, a stack of thin layers acting as interference filter, or also a stack of thin layers exhibiting a gradient of refractive indices.

In this example, the central layer deposited by magnetron on the satin finish glass provides the diffuse reflection which makes possible the direct projection of an image, whereas the sol-gel planarization layer makes it possible to maintain the transparency of the glazing in transmission. The addition of the back glass plate with antireflection treatment makes it possible to reduce the multiple reflections inside the glazing and thus to improve the quality of the projected images.

FIGS. 4 and 5 illustrate two other projection systems according to the invention, the glazing 5 of which incorporates an electrically controllable variable light scattering system 7 which can switch between a transparent state and a scattering state. In the “OFF” state, a glazing is obtained which comprises a scattering main external surface which makes possible an improved direct projection as the diffuse reflection on the magnetron layer is added to the diffuse reflection on the liquid-crystal film. In the “ON” state, a glazing is obtained which comprises a transparent main external surface, the functioning of which is the same as without a variable light scattering system.

The glazing illustrated in FIG. 4 comprises the following stack:
a layered element comprising:
   a lower external layer 2 comprising a substrate made of rough glass,
   a central layer 3 comprising a thin layer based on silver or stainless steel,
   an upper external layer 4 composed of a sol-gel layer,
an additional layer 12a composed of an insert made of thermoformable or pressure-sensitive plastic,
a variable light scattering system 7 comprising a functional film 16 framed by two electrode-carrying supports, a lower electrode-carrying support 9 and an upper electrode-carrying support 11, said electrodes being directly in contact with the functional film 16,
an upper additional layer 12a composed of an insert made of thermoformable or pressure-sensitive plastic,
another upper additional layer 12b composed of a transparent substrate made of flat glass comprising an antireflection coating 6.

The electrode-carrying supports are sheets made of plastic composed of polyethylene terephthalate on which the electrodes have been deposited. The electrode can be an electrically conducting layer with a thickness of approximately 20 to 400 nm made of indium tin oxide (ITO), for example. The ITO layers have a surface electrical resistance of between 5 Ω/square and 300 Ω/square. Instead of the layers made of ITO, it is also possible to use, for the same purpose, other layers of electrically conducting oxide or layers of silver having a comparable surface resistance. Finally, the functional film 16 is composed of a layer of liquid crystals.

Finally, the glazing illustrated in FIG. 5 represents the embodiment according to which the layered element performs the role of electrode-carrying support. The glazing illustrated in FIG. 5 comprises the following stack:
a layered element 1 comprising:
   a lower external layer 2 comprising a substrate made of rough glass,
   a central layer 3 comprising a thin layer, preferably a metallic layer,
   an upper external layer 4 composed of tin zinc oxide exhibiting a resistivity of less than 1 ohm·cm,
a functional film 16,
an upper electrode-carrying support 11,
an upper additional layer 12a composed of an insert made of thermoformable or pressure-sensitive plastic,
another upper additional layer 12b composed of a transparent substrate made of flat glass comprising an antireflection coating 6.

The lower external layer 2 of the layered element performs the role of support for the assembly composed of the central layer and the upper external layer, which assembly performs, for its part, the role of electrode. The layered element 1 thus constitutes a lower electrode-carrying support.

The variable light scattering system 7 comprises a functional film 16 framed by two electrode-carrying supports, a lower electrode-carrying support 9 composed of the layered element 1 and an upper electrode-carrying support 11, said electrodes being directly in contact with the functional film.

An example of a process for the manufacture of the glazing of the invention is described below with reference to FIG. 6. According to this process, the central layer 3 is deposited conformably on a textured surface 2B of a rigid or flexible transparent substrate forming the external layer 2 of the layered element 1. The main surface 2A of this substrate, opposite the textured surface 2B, is smooth. This substrate 2 can in particular be a textured glass substrate of Satinovo®, Albarino® or Masterglass® type. In an alternative form, the substrate 2 can be a substrate based on polymer material which is rigid or flexible, for example of polymethyl methacrylate or polycarbonate type.

The conforming deposition of the central layer 3, whether it is a monolayer or formed by a stack of several layers, is in particular carried out, preferably, under vacuum, by magnetic-field assisted cathode sputtering (“magnetron cathode” sputtering). This technique makes it possible to deposit, on the textured surface 2B of the substrate 2, either the single layer conformably or the different layers of the stack conformably in succession. They can in particular be thin transparent layers, preferably dielectric layers, in particular layers of Si₃N₄, SnO₂, ZnO, ZrO₂, SnZnOₓ, AlN, NbO, NbN, TiO₂, SiO₂, Al₂O₃, MgF₂ or AlF₃, or thin metallic layers, in particular layers of silver, gold, titanium, niobium, silicon, aluminum, nickel-chromium alloy (NiCr) or alloys of these metals.

In the process of FIG. 6, the second external layer 4 of the layered element 1 can be formed by covering the central layer 3 with a transparent sol-gel layer having a refractive index substantially equal to that of the substrate 2, which is initially provided in a viscous state suitable for shaping operations and which is curable. This layer will, in the liquid or pasty viscous state, match the texture of the surface 3B of the central layer 3 opposite the substrate 2. Thus, it is guaranteed that, in the cured state of the layer 4, the contact surface S₁ between the central layer 3 and the external layer 4 is indeed textured and parallel to the contact surface S₀ between the central layer 3 and the external layer 2.

The external layer 4 of the layered element 1 of FIG. 6 is a sol-gel layer deposited by a sol-gel process on the textured surface of the central layer 3.

Finally, one or more additional layers 12 can be formed above the layered element. In this case, the additional layer or layers are preferably a flat glass substrate, a plastic insert or a superimposition of an insert and a flat glass substrate.

When the external layer of the layered element was obtained from a sol-gel layer, certain irregularities may exist on the smooth main external surface of this layer. In order to compensate for these irregularities, it may be advantageous to form an additional layer 12 on this sol-gel layer by positioning a laminating PVB or EVA insert against the smooth main external surface of the layered element. The additional layer 12 has, in this case, substantially the same refractive index as the external layer of the layered element obtained from a sol-gel process.

The additional layer can also be a transparent substrate, for example a flat glass. In this case, the additional layer is used as a counter-substrate. The sol-gel layer then provides integrality between the lower external layer provided with the central layer and the counter-substrate.

The use of a transparent substrate as upper additional layer is of particular use when the additional layer directly below said upper additional layer is formed by a laminating polymer insert.

A first additional layer 12 formed by a laminating PVB or EVA insert can be positioned against the upper external surface of the layered element and a second additional layer 12 composed of a flat glass substrate can be positioned above the insert.

In this configuration, the additional layers are combined with the layered element by a conventional laminating process. In this process, the laminating polymer insert and the substrate are successively positioned, starting from the upper main external surface of the layered element, and then compression and/or heating, at least to the glass transition temperature of the laminating polymer insert, for example in a press or an oven, is/are applied to the laminated structure thus formed.

During this laminating process, when the insert forms the upper additional layer located directly above the layered element, the upper layer of which is a sol-gel layer, it conforms both to the upper surface of the sol-gel layer and to the lower surface of the flat glass substrate.

In the process illustrated in FIG. 7, the layered element 1 is a flexible film with a total thickness of the order of 200-300 μm. The layered element is formed by the superimposition:
of a lower additional layer 12 formed by a flexible polymeric film,
of an external layer 2 made of material which can photocrosslink and/or photopolymerize under the action of a UV radiation applied against one of the smooth main surfaces of the flexible film,
of a central layer 3,
of a sol-gel layer having a thickness of approximately 15 μm, so as to form the second external layer 4 of the layered element 1.

The flexible film forming the lower additional layer can be a film of polyethylene terephthalate (PET) having a thickness of 100 μm and the external layer 2 can be a layer of resin curable under UV radiation of KZ6661 type, sold by JSR Corporation, having a thickness of approximately 10 μm. The flexible film and the layer 2 both have substantially the same refractive index, of the order of 1.65 at 550 nm. In the cured state, the layer of resin exhibits a good adhesion with PET.

The layer of resin 2 is applied to the flexible film with a viscosity which makes it possible to introduce a texturing to its surface 2B opposite the film 12. As illustrated in FIG. 7, the texturing of the surface 2B can be carried out using a roll 13 having, at its surface, a texturing complementary to that to be formed on the layer 2. Once the texturing has been formed, the superimposed flexible film and layer of resin 2 are irradiated with a UV radiation, as shown by the arrow in FIG. 7, which makes it possible to solidify the layer of resin 2 with its texturing and to assemble together the flexible film and the layer of resin 2.

The central layer 3 with a refractive index different from that of the external layer 2 is subsequently deposited conformably on the textured surface 2B by magnetron cathode sputtering. This central layer can be a monolayer or be formed by a stack of layers, as described above. It can, for example, be a layer of TiO₂ having a thickness of between 55 and 65 nm, i.e. of the order of 60 nm, and a refractive index of 2.45 at 550 nm.

The sol-gel layer is subsequently deposited on the central layer 3 so as to form the second external layer 4 of the layered element 1. This second external layer 4 conforms to the textured surface 3B of the central layer 3 opposite the external layer 2.

A layer of adhesive 14 covered with a protective strip (liner) 15 intended to be removed for the adhesive bonding can be added to the external surface 4A of the layer 4 of the layered element 1. The layered element 1 is thus provided in the form of a flexible film ready to be added by adhesive bonding to a surface, such as a surface of a glazing, in order to confer diffuse reflection properties on this surface. In the example of FIG. 7, the layer of adhesive 14 and the protective strip 15 are added to the external surface 4A of the layer 4. The external surface 2A of the layer 2, which is intended to receive an incident radiation, is, for its part, provided with an antireflection coating.

Particularly advantageously, as suggested in FIG. 7, the different stages of the process can be carried out continuously on one and the same manufacturing line.

The introduction of the antireflection coating or coatings of the layered element 1 has not been represented in FIGS. 6 and 7. It should be noted that, in each of the processes illustrated in these figures, the antireflection coating or coatings can be introduced onto the smooth surfaces 2A and/or 4A of the external layers before or after the assembling of the layered element, without distinction.

The invention is not limited to the examples described and represented. In particular, when the layered element is a flexible film, as in the example of FIG. 7, the thickness of each external layer formed based on a polymer film, for example based on a film of PET, can be greater than 10 μm, in particular of the order of 10 μm to 1 mm.

Furthermore, the texturing of the first external layer 2 in the example of FIG. 7 can be obtained without resorting to a layer of curable resin deposited on the polymer film but directly by hot embossing a polymer film, in particular by rolling using a textured roll or by pressing using a punch.

Analogous architectures can also be envisaged for plastic substrates in place of glass substrates.

The use of the glazing thus defined as projection screen operating in reflection makes it possible to improve the contrast and/or the luminosity and/or the angle of view.

The glazing according to the invention can be used in particular as internal partition (between two rooms or in a space) in a building. More particularly, the glazing of the invention is of particular use as internal partition of a meeting room for projecting presentations. It is possible to switch between the transparent state and the scattering state.

The glazing according to the invention is capable of being used for any known application of glazings, such as for vehicles, buildings, street furniture, internal furnishings, lighting, display screens, and the like. The transparent glazing of the invention can thus be used as facade, as window, as internal partition which can be used as projection screen for meeting rooms or display cabinets. The glazing can also be used for museography or advertizing on a sales outlet as advertizing support.

It can also be a flexible polymer-based film capable in particular of being added to a surface in order to confer diffuse reflection properties thereon while retaining its transmission properties.

The glazing having strong diffuse reflection of the invention can be used in a Head Up Display (HUD) system. In a known way, HUD systems, which are used in particular in aircraft cockpits and trains but also today in motor vehicles of private individuals (motor vehicles, trucks, and the like), make it possible to display information projected onto a glazing, generally the windshield of the vehicle, which is reflected toward the driver or the observer. These systems make it possible to inform the driver of the vehicle, without him looking away from the field of view forward of the vehicle, which makes possible a great increase in safety.

According to one aspect of the invention, the layered element is incorporated in an HUD system as glazing, onto which information is projected. According to another aspect of the invention, the layered element is a flexible film added to a main surface of a glazing of an HUD system, in particular a windshield, the information being projected onto the glazing on the side of the flexible film. In both these cases, a strong diffuse reflection takes place on the first textured contact surface encountered by the radiation in the layered element, which makes possible good viewing of the virtual image, while the specular transmission through the glazing is retained, which guarantees sharp viewing through the glazing.

It is noted that, in the HUD systems of the state of the art, the virtual image is obtained by projecting the information onto a glazing (in particular a windshield) having a laminated structure formed of two glass sheets and a plastic insert. One disadvantage of these existing systems is that the driver then observes a double image: a first image reflected by the surface of the glazing directed toward the inside of the compartment and a second image by reflection from the external surface of the glazing, these two images being slightly offset with respect to one another. This offsetting can disturb the viewing of the information.

The invention makes it possible to overcome this problem. This is because, when the layered element is incorporated in an HUD system, as glazing or as a flexible film added to the main surface of the glazing which receives the radiation from the projection source, the diffuse reflection on the first textured contact surface encountered by the radiation in the layered element can be markedly greater than the reflection on the external surfaces in contact with the air. Thus, the double reflection is limited by favoring the reflection on the first textured contact surface of the layered element.

### EXAMPLES

### I. Materials Used

1. Layered Element

These tests were carried out with a layered element comprising the following stack:
Lower external layer: Satinovo® glass substrate,
Central layer: layer based on silver or stainless steel deposited by magnetron,
Upper external layer: sol-gel layer.

The substrates used as lower external layer of the layered element are Satinovo® transparent rough glass satin finish substrates sold by Saint-Gobain. These substrates, with a thickness of 6 mm, comprise a textured main surface obtained by acid attack. These substrates are thus used as lower external layer of the layered element. The mean height of the patterns of the texturing of this lower external layer, which corresponds to the roughness Ra of the textured surface of the Satinovo® glass, is between 1 and 5 μm. Its refractive index is 1.518 and its PV (peak to valley) is between 12 and 17 μm.

The central layer is a layer or a stack of layers deposited by magnetron deposition conformably on the textured surface of the Satinovo® substrate corresponding to:
a stack comprising a silver-based layer referenced KN 169 from Saint-Gobain exhibiting, when it is deposited on a flat glass substrate with a thickness of 6 mm, a light transmission LT of 69%,
a stack comprising a layer based on stainless steel referenced SS 132 from Saint-Gobain exhibiting, when it is deposited on a flat glass substrate with a thickness of 6 mm, a light transmission LT of 32%.

The sol-gel layer comprises a silica-based matrix in which particles of metal oxide are dispersed. It exhibits a refractive index of 1.51 and a thickness of approximately 15 μm.

2. Variable Scattering System (VSS)

The variable scattering system (VSS1) comprises, as electrode-carrying supports, two polyethylene terephthalate sheets covered with an ITO layer and framing the functional film, that is to say the medium comprising the droplets of liquid crystals. This variable scattering system is currently used in the Priva-Lite® glazings from Saint-Gobain Glass. The functional film comprising the liquid emulsion of nematic liquid crystals has a thickness of approximately 10 to 30 μm (preferably of 20 to 25 μm). The PET sheets have a thickness of approximately 175 μm. The two electrodes are composed of ITO (tin-doped indium oxide) with a resistance of approximately 100 ohms per square.

3. Other Substrates

Other substrates (or back glass plate) can be used to form the glazing of the invention. These substrates can be laminated by using, for example, an insert made of PVB or EVA. Mention may be made, as substrate, of flat glasses, such as a Planilux® or Diamant® glass.

It is also possible to use flat glasses comprising one or more antireflection coatings obtained by deposition, by vacuum cathode sputtering, of layers of metal oxides. The antireflection effect is obtained by the deposition of a layer on each external face of the glass. Such glasses are, for example, sold under the Visionlite® name by Saint-Gobain.

### II. Influence of the Nature of the Central Layer

This test compares two glazings according to the invention differing only in the nature of the central layer. In order to compare the glazings used as projection screen of the invention, a panel of several people visually assessed the luminosity and the transparency of the glazings when an image is projected in direct projection. The projected image evaluated by the panel has formed the subject of the photograph Z in FIG. 9. The images were projected onto the side of the glazing not comprising the antireflection coating. The panel assigned, for each image projected onto a glazing, an assessment indicator chosen from: “−−” poor, “−” fair, “0” correct, “+” good, “++” excellent.

| Stack | Ex. 1 | Ex. 2 |
|---|---|---|
| Transparent element having diffuse | KN169 | SS132 |
| reflection: | | |
| Substrate made of Satinovo ® | | |
| glass | | |
| magnetron layer | | |
| sol-gel layer | | |
| Insert (PVB) | Yes | Yes |
| Substrate made of Visionlite ® | Yes | Yes |
| glass | | |
| Photograph Z | Right-hand image | Left-hand image |
| luminosity | + | ++ |
| transparency | ++ | + |
| contrast | + | ++ |

The photograph Z respectively illustrates a projection onto a diffuse reflection glazing provided with a KN169 layer on the left-hand side and with an SS132 layer on the right-hand side. The glazing of example 1 is more transparent but the luminosity of the projected image is lower. In contrast, the glazing of example 2 is less transparent but the luminosity of the projected image is greater. For these two examples, the contrast and the angle of view are good.

This example illustrates that the choice of the central layer and more particularly the choice of its reflection properties has to be adjusted as a function of the application desired and the rendering desired. For ambient light in the projection room, a compromise between transparency of the glazing and luminosity of the projected image can be obtained by varying the properties of the central layer.

### III. Glazings Comprising a Transparent Element Having a Diffuse Property

The examples of the invention were carried out by laminating, by virtue of laminating inserts, the following stack: rated transparent element having a diffuse reflection property (sol-gel layer)/variable light scattering system/Vision-Lite® glass.

The comparative example was carried out by laminating, by virtue of laminating inserts, the following stack: flat glass substrate/variable light scattering system/Vision-Lite® glass.

In order to show the superior quality of the glazings used as projection screen of the invention, a panel of several people visually assessed the luminosity and the contrast of the glazings when an image is projected in direct projection, that is to say with the observers and the projector located on the same side of the glazing. Each projected image evaluated by the panel has formed the subject of a photograph. These photographs have been combined in FIG. 8. The images were projected onto the side of the glazing not comprising the antireflection coating,

| | Comparative | | |
|---|---|---|---|
| Stack | Example | Ex. 3 | Ex. 4 |
| Glass substrate | Yes | No | No |
| Transparent element having diffuse | No | Yes | Yes |
| reflection: | | | |
| Substrate made of Satinovo ® | | KN169 | SS132 |
| glass | | | |
| magnetron layer | | | |
| sol-gel layer | | | |
| Insert (EVA) | Yes | Yes | Yes |
| VSS | 1 | 1 | 1 |
| Insert (EVA) | Yes | Yes | Yes |
| Substrate made of Visionlite ® glass | Yes | Yes | Yes |

The panel assigned, for each image projected onto a glazing, an assessment indicator chosen from: “−−” poor, “−” fair, “0” correct, “+” good, “++” excellent. The glazings, evaluation condition and assessment of the panel, and also the reference to the corresponding photograph, are summarized in the table below.

| | | | | Quality of the screen | |
|---|---|---|---|---|---|
| Photographs | Glazing | Angle of view | State | luminosity | contrast |
| A | Comp. ex. | face | ON | + | + |
| B | Ex. 3 | face | ON | + | + |
| C | Ex. 4 | face | ON | ++ | ++ |
| D | Comp. ex. | 45° | ON | −− | −− |
| E | Ex. 3 | 45° | ON | + | + |
| F | Ex. 4 | 45° | ON | ++ | ++ |
| G | Comp. ex. | face | OFF | ++ | ++ |
| H | Ex. 3 | face | OFF | ++ | ++ |
| I | Ex. 4 | face | OFF | + | + |
| J | Comp. ex. | 45° | OFF | − | − |
| K | Ex. 3 | 45° | OFF | + | + |
| L | Ex. 4 | 45° | OFF | ++ | ++ |

Photographs A, B, C, D, E and F were taken with the variable light scattering system in the ON state, that is to say transparent state. It is found that, in the transparent state, a glazing comprising only a variable light scattering system is unusable with angles of view of 45° (photograph D). The luminosity of the screen strongly decreases when the angle of observation increases. In comparison, a glazing additionally comprising at least the variable light scattering system and, in the case of the examples, an antireflection layer makes possible a marked improvement in the quality of the image for angles of view of the order of 45° (photographs E and F).

Photographs G, H, I, J, K and L were taken with the variable light scattering system in the OFF state, that is to say scattering state. An improvement in the luminosity face on is observed (photographs G, H and I). On the other hand, in the scattering state, a glazing comprising only a variable light scattering system is of mediocre quality for angles of view of 45° (photograph J). The angle of view of such screens in projection, even in the scattering state, is greatly reduced, rendering them unusable. In comparison, a glazing additionally comprising at least the variable light scattering system and, in the case of the examples, an antireflection layer makes possible a marked improvement in the quality of the image for high angles of view (photographs K and L). Consequently, the angle of view for the direct projection is improved on the glazing of the invention as a result of an isotropic scattering reflection of the magnetron layer on Satinovo® glass.

Finally, examples 3 and 4 differ essentially in the choice of the central layer. The same tendency relating to the luminosity and the contrast is observed as for examples 1 and 2, which respectively exhibit the same central layers (KN 169 and SS132).

### IV. Analysis of the Contrast

Measurements of the contrast were carried out under specific illumination conditions in order to test the projection screens of the invention. When the projection room is not illuminated (“OFF” surroundings), the mean illumination is 1 lux and, when the projection room is lit up (“ON” surroundings), the mean illumination is 195 lux.

The luminance measurement is carried out at the surface of the glazing with a Konica-Minolta® LS-110 luminance meter. The image projection is carried out with a Canon® XEED SX80 video projector (luminosity, 3000 lumens, contrast 900:1).

The arrangement of the elements is as follows. The video projector is located 1.5 m from the screen. The observers and the photographic apparatus are located 2 m from the screen.

This test makes it possible to measure the contrast of the glazing as projection screen. The contrast is defined as the ratio of the luminance measured when the projector displays a white image (Lw) to the luminance measured when the projector displays a dark image (Lb).

The luminance measurements carried out on the screens in the scattering state (OFF glazing) or transparent state (ON glazing) are given in the table below.

The measurement of the contrast on a perfectly transparent glazing has the value 1.

| | Angle | | | | | | Contrast |
|---|---|---|---|---|---|---|---|
| | of | | | Luminance | Luminance | | Improvement |
| Glazing | view | Surroundings | Glazing | of White | of Black | Contrast | % |
| Comp. ex. | Face | ON | ON | 460 | 41 | 11.2 | |
| Ex. 3 | Face | ON | ON | 296 | 31.2 | 9.5 | −15% |
| Comp. ex. | Face | ON | OFF | 732 | 36.5 | 20.1 | |
| Ex. 3 | Face | ON | OFF | 615 | 27.9 | 22.0 | 9% |
| Comp. ex. | Face | OFF | ON | 401 | 1.15 | 348.7 | |
| Ex. 3 | Face | OFF | ON | 266 | 0.56 | 475.0 | 36% |
| Comp. ex. | Face | OFF | OFF | 708 | 1.8 | 393.3 | |
| Ex. 3 | Face | OFF | OFF | 599 | 1.1 | 544.5 | 38% |
| Comp. ex. | 45° | ON | ON | 39.8 | 23.7 | 1.7 | |
| Ex. 3 | 45° | ON | ON | 57.3 | 16.9 | 3.4 | 100% |
| Comp. ex. | 45° | ON | OFF | 81.7 | 18 | 4.5 | |
| Ex. 3 | 45° | ON | OFF | 79.4 | 12.3 | 6.5 | 44% |
| Comp. ex. | 45° | OFF | ON | 15.9 | 0.15 | 106.0 | |
| Ex. 3 | 45° | OFF | ON | 40 | 0.12 | 333.3 | 214% |
| Comp. ex. | 45° | OFF | OFF | 65.4 | 0.2 | 327.0 | |
| Ex. 3 | 45° | OFF | OFF | 67 | 0.15 | 446.7 | 36% |

These tests confirm that, in the transparent state, a glazing comprising only a variable light scattering system is unusable with angles of view of 45°. The presence of the layered element makes possible an increase in the contrast of greater than 35% in all the cases for an angle of view of 45°.

In the scattering state, a glazing comprising only a variable light scattering system is of mediocre quality for angles of view of 45° (contrast of 1.7). In comparison, a glazing of the invention makes possible a marked improvement in the quality of the image for high angles of view. The improvement in the contrast is in particular 100% when the room is illuminated and 214% when the room is dark.

1. A projection or back-projection method comprising projecting, by virtue of a projector, images viewable by a spectator onto a side of a glazing that includes two main external surfaces, used as projection or back projection screen, said glazing comprising a transparent layered element having two smooth main external surfaces, the transparent layered element comprising
two external layers, which each form one of the two smooth main external surfaces of the transparent layered element and which are composed of transparent materials having substantially a same refractive index, and
a central layer inserted between the two external layers, the central layer being formed either (a) by a single layer which is a transparent layer with a refractive index different from that of the two external layers, or a metallic layer, or (b) by a stack of layers which comprises at least one transparent layer with a refractive index different from that of the external layers, or a metallic layer,
wherein each contact surface between two adjacent layers of the transparent layered element, one of which being transparent with a refractive index and the other metallic or which are both transparent layers with different refractive indices, is textured and parallel to the other textured contact surfaces between two adjacent layers, one of which being transparent with a refractive index and the other metallic or which are both transparent layers with different refractive indices.

2. The projection or back-projection method as claimed in claim 1, wherein the glazing additionally comprises at least one antireflection coating.

3. The projection or back-projection method as claimed in claim 2, wherein the glazing comprises at least one antireflection coating at an interface between air and a constituent material of the layer forming one of the two main external surfaces of the glazing, on the opposite side of the glazing with respect to the projector.

4. The projection or back-projection method as claimed in claim 1, wherein the glazing additionally comprises a variable light scattering system comprising a functional film capable of switching between a transparent state and a scattering state.

5. The projection or back-projection method as claimed in claim 4, wherein the variable light scattering system is electrically controllable and comprises a functional film framed by two electrode-carrying supports, said electrodes being directly in contact with the functional film.

6. The projection or back-projection method as claimed in claim 5, wherein the transparent layered element constitutes one of the two electrode-carrying supports of the variable light scattering system, one of the two external layers performs the role of support and an assembly composed of the central layer and of the other one of the two external layers performs the role of electrode.

7. The projection or back-projection method as claimed in claim 4, wherein the variable light scattering system is formed taking into account a portion only of the main external surfaces of the glazing.

8. The projection or back-projection method as claimed in claim 1, wherein the transparent layered element is formed taking into account a portion only of the main external surfaces of the glazing.

9. The projection or back-projection method as claimed in claim 1, wherein the transparent layered element is a flexible film.

10. The projection or back-projection method as claimed in claim 1, wherein the glazing further comprises at least one additional layer positioned above or below the transparent layered element and/or optionally a variable light scattering system, the at least one additional layer chosen from:
transparent substrates chosen from polymers, glasses or ceramics comprising two smooth main surfaces,
curable materials initially in a liquid or pasty viscous state suitable for shaping operations,
inserts made of thermoformable or pressure-sensitive plastic.

11. The projection or back-projection method as claimed in claim 1,
wherein a first of the two external layers is a lower external layer arranged closer to the projector and chosen from transparent substrates made of rough glass, and
a second of the two external layers is an upper external layer chosen from curable materials initially in a liquid or pasty viscous state suitable for shaping operations,
the glazing further comprising
an insert made of thermoformable or pressure-sensitive plastic, and
a transparent substrate made of flat glass.

12. The projection or back-projection method as claimed in claim 11, wherein the glazing further comprises:
another insert made of thermoformable or pressure-sensitive plastic, and
a variable light scattering system comprising a functional film framed by two electrode-carrying supports, said electrodes being directly in contact with the functional film, the other insert made of thermoformable or pressure-sensitive plastic arranged between the transparent layered element and the variable light scattering system.

13. The projection method as claimed in claim 1, wherein the glazing is used as a projection screen operating in reflection so that the spectator and the projector are located on a same side of the glazing used as projection screen.

14. A glazing with two main external surfaces, the glazing comprising:
at least one transparent layered element having two smooth main external surfaces, the at least one transparent layered element comprising
two external layers, which each form one of the two smooth main external surfaces of the at least one transparent layered element and which are composed of transparent materials having substantially a same refractive index, and
a central layer inserted between the two external layers, the central layer being formed either (a) by a single layer which is a transparent layer with a refractive index different from that of the two external layers, or a metallic layer, or (b) by a stack of layers which comprises at least one transparent layer with a refractive index different from that of the external layers, or a metallic layer,
wherein each contact surface between two adjacent layers of the layered element, one of which being transparent with a refractive index and the other metallic or which are both transparent layers with different refractive indices, is textured and parallel to other textured contact surfaces between two adjacent layers, one of which being transparent with a refractive index and the other metallic or which are both transparent layers with different refractive indices, and
at least one variable light scattering system.

15. The glazing as claimed in claim 14, wherein
the at least one variable light scattering system comprises a functional film framed by two electrode-carrying supports, said electrodes being directly in contact with the functional film,
the glazing further comprising
a first insert made of thermoformable or pressure-sensitive plastic arranged between the at least one transparent layered element and the at least one variable light scattering system,
a second insert made of thermoformable or pressure-sensitive plastic, and
a transparent substrate made of flat glass.

16. The projection or back-projection method as claimed in claim 1, wherein the transparent materials of the two external layers are dielectric materials.

17. The projection or back-projection method as claimed in claim 1, wherein the single layer is a dielectric layer.

18. The projection or back-projection method as claimed in claim 1, wherein the at least one transparent layer is a dielectric layer.

18. The projection or back-projection method as claimed in claim 11, wherein the central layer is a thin layer.

19. The projection or back-projection method as claimed in claim 11, wherein the upper external layer is a sol-gel layer.

20. The projection or back-projection method as claimed in claim 12, wherein the transparent substrate made of flat glass comprises at least one antireflection coating.

21. The glazing as claimed in claim 14, wherein the transparent materials of the two external layers are dielectric materials.

22. The glazing as claimed in claim 14, wherein the single layer is a dielectric layer.

23. The glazing as claimed in claim 14, wherein the at least one transparent layer is a dielectric layer.

24. The glazing as claimed in claim 14, wherein the at least one variable scattering system is electrically controllable.

25. The glazing as claimed in claim 15, wherein the transparent substrate made of flat glass comprises at least one antireflection coating.
